(19) United States
(12) Patent Application Publication
(10) Pub. No.: US 2026/0269874 A1
(43) Pub. Date: Sep. 10, 2026

(54) SIGNALING FOR DEPLOYING LIQUID CRYSTAL (LC) BASED RIS

(71) Applicant: QUALCOMM Incorporated, San Diego, CA (US)

(72) Inventors: Narayan PRASAD, Westfield, NJ (US); Navid ABEDINI, Basking Ridge, NJ (US); Junyi LI, Greentown, PA (US); Tao LUO, San Diego, CA (US)

(21) Appl. No.: 19/075,596

(22) Filed: Mar. 10, 2025

(51) Int. Cl. H04B 7/04; H04B 7/06

(52) U.S. Cl. CPC H04B 7/04013; H04B 7/06952

(57) ABSTRACT

A method for wireless communication at a reconfigurable intelligent surface (RIS) device and related apparatus are provided. In the method, the RIS device receives, from a network entity, a first pattern configuration indicative of a first set of RIS patterns. The first set of RIS patterns includes two or more RIS patterns being adapted based on transition time information for two or more transitions between the two or more RIS patterns, and the transition time information for each transition of the two or more transitions is based on a change between a first RIS pattern and a second RIS pattern and a direction of the change. The RIS device further communicates with a first user equipment (UE) based on the first set of RIS patterns.

### TECHNICAL FIELD

The present disclosure relates generally to communication systems and, more particularly, to wireless communication via a reconfigurable intelligent surface (RIS) device.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive transition time information for two or more transitions between two or more reconfigurable intelligent surface (RIS) patterns in a first set of RIS patterns for an RIS device, where the transition time information for each transition of the two or more transitions is based on a change between a first RIS pattern and a second RIS pattern and a direction of the change; and communicate with the RIS device based on the first set of RIS patterns. The first set of RIS patterns is based on the transition time information.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to an RIS device, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and communicate, via the RIS device, with a first UE based on the first set of RIS patterns.

In an aspect of the disclosure, a method, a computer-readable medium, and an apparatus are provided for wireless communication at an RIS device. The apparatus may include at least one memory and at least one processor coupled to the at least one memory. Based at least in part on information stored in the at least one memory, the at least one processor may be configured to receive, from a network entity, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and communicate with a first UE based on the first set of RIS patterns.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A illustrates a blockage to wireless communication between a base station and a UE.

FIG. 4B illustrates a reconfigurable intelligent surface (RIS) that intelligently reflects communication between a base station and a UE.

FIG. 5 illustrates an RIS that intelligently reflects communication between a base station and a UE.

FIG. 6 is a diagram illustrating an example operation of an RIS device.

FIG. 7 is a diagram illustrating an example pattern transition time (PAT) table in accordance with various aspects of the present disclosure.

FIG. 8 is a diagram illustrating an example beam sweeping process using an RIS device.

FIG. 9A is a diagram illustrating an example of burst communication with multiple users via an RIS device in accordance with various aspects of the present disclosure.

FIG. 9B is a diagram illustrating different orders of serving multiple users in burst communication via an RIS device in accordance with various aspects of the present disclosure.

FIG. 10 is a diagram illustrating example codewords for an RIS device in accordance with various aspects of the present disclosure.

FIG. 11 is a diagram illustrating an example of using companion codewords in an RIS device in response to temperature changes in accordance with various aspects of the present disclosure.

FIG. 12 is a diagram illustrating an example of using companion codewords in an RIS device in response to changes in interference conditions in accordance with various aspects of the present disclosure.

FIG. 13A is a diagram illustrating an example of configured grant operations via an RIS device in accordance with various aspects of the present disclosure.

FIG. 13B is a diagram illustrating an example of configured grant operations via an RIS device in accordance with various aspects of the present disclosure.

FIG. 14 is a call flow diagram illustrating the selection of codeword (or companion codeword) for an RIS device in accordance with various aspects of the present disclosure.

FIG. 15 is a call flow diagram illustrating a method of wireless communication in accordance with various aspects of the present disclosure.

FIG. 16 is a flowchart illustrating methods of wireless communication at a reconfigurable intelligent surface (RIS) device in accordance with various aspects of the present disclosure.

FIG. 17 is a flowchart illustrating methods of wireless communication at an RIS device in accordance with various aspects of the present disclosure.

FIG. 18 is a flowchart illustrating methods of wireless communication at a network entity in accordance with various aspects of the present disclosure.

FIG. 19 is a flowchart illustrating methods of wireless communication at a network entity in accordance with various aspects of the present disclosure.

FIG. 20 is a flowchart illustrating methods of wireless communication at a UE in accordance with various aspects of the present disclosure.

FIG. 21 is a diagram illustrating an example of a hardware implementation for an example apparatus and/or UE.

FIG. 22 is a diagram illustrating an example of a hardware implementation for an example network entity.

FIG. 23 is a diagram illustrating an example of a hardware implementation for a RIS.

### DETAILED DESCRIPTION

A reconfigurable intelligent surface (RIS) device may have an array of reflecting elements, each capable of dynamic reconfiguration to control the reflection and scattering of electromagnetic waves. An RIS (or RIS panel) may include a larger number of uniformly distributed electrically controllable elements, and each RIS element may have a reconfigurable electromagnetic characteristic, e.g., a reflection coefficient. Each RIS element may have the capability to change at least one of the properties of the incident radio waves including frequency, amplitude, phase and polarization. The radio wave may be at least reflected or transmitted to another direction after hitting the RIS panel, depending on the design of RIS. An RIS device may use techniques such as diodes (e.g., PIN diodes or varactor) and radio frequency (RF) switches to achieve the reconfigurability. However, each of these techniques may limit the scalability of the device. On the other hand, certain types of RIS elements, such as RIS elements liquid crystal (LC), can be configured to achieve desired phase-shifts and may be used in an RIS device for wireless communication, including communication at sub-terahertz and millimeter-wave (e.g., 60 GHz) frequency ranges. In these RIS devices (e.g., an LC-based RIS or LC-RIS), each codeword or pattern of the RIS device may be generated by applying a set of biasing voltages across the elements. The voltage applied to each element alters the permittivity of the associated layer, thereby changing its electrical length, which in turn determines the phase shift of the reflected RF signals. The response of each RIS element to the voltage changes depends on various factors, e.g., including the operating ambient temperature, the layer's thickness, and/or other material properties. Hence, the transition times for switching between different patterns of the RIS elements (e.g., the time for each of the elements of the RIS device to assume its new configuration after the reconfiguration is instructed or activated) may vary depending on the voltages used to achieve the desired phase shifts between these patterns. Additionally, the transition times between different patterns may be asymmetric or direction dependent, meaning that the transition time for switching from pattern A to pattern B may be different from the transition time for switching back from pattern B to the pattern A. Example aspects presented herein provide methods and apparatus to improve the operation of RIS devices (e.g., LC-based RIS devices), including signaling and procedures such as configuration, exchange of RIS pattern transition time information and/or configuration of companion (second-stage) codebooks with associated pattern transition times, margins, ambient temperature information, and spatial relations (e.g., spatial quasi co-location (QCL) relations). As used herein, a “pattern” (or “codeword”) of an RIS device refers to a configuration of the RIS device to manipulate electromagnetic waves in a designated manner, such as applying a phase shift or directing reflections at a specific angle. Since an RIS device includes multiple individual elements, a “pattern” of an RIS device can be achieved by adjusting the settings of each element to achieve the desired wave manipulation.

Various aspects relate generally to wireless communication. Some aspects more specifically relate to operations of an RIS device, including an LC based RIS device. In some examples, an RIS device receives a first pattern configuration indicative of a first set of RIS patterns from a network entity. The first set of RIS patterns may be based on transition time information for two or more transitions, and the transition time information for each transition of the two or more transitions may be based on the change of the RIS pattern between a first RIS pattern to a second RIS pattern and the direction of the change. The RIS device then communicates with a first UE based on the first set of RIS patterns. In some examples, the transition time information may include a pattern transition time table, and the entries of the pattern transition time table may include transition times between two RIS patterns. In some examples, the transition time information may be utilized to optimized various tasks associated with the RIS device, including a beam sweeping process, burst communication with multiple users. For example, the beam order of the beam sweeping process or the order for communication with the multiple users in the burst communication may be determined based on the transition time information for the two or more transitions. In some examples, at least one RIS pattern in the first set of RIS patterns may be associated with one or more companion patterns (which may also refer to as “refinement patterns”), and the association of the at least one RIS pattern with the one or more companion patterns (or refinement patterns) may be based on the transition time information for the transitions among the at least one RIS pattern and the one or more companion patterns (or refinement patterns). In some examples, the RIS device may switch from the at least one RIS pattern to one companion pattern (or refinement pattern) associated with the at least one RIS pattern based on factors such as changes in environmental conditions, such as the temperature, or changes in interference conditions.

Particular aspects of the subject matter described in this disclosure can be implemented to realize one or more of the following potential advantages. In some examples, by utilizing transition time information for the transitions between the RIS patterns to optimize the beam orders in various operations, including beam sweeping and/or burst communication, the described techniques reduce the time to adjust the RIS configuration across multiple patterns, thereby improving the overall responsiveness of the network to changes in network condition and environment. In some examples, by configuring companion (or second-stage) codebooks with associated pattern transition times, margins, and ambient temperature information, the described techniques can be used to adjust the RIS configurations based on environmental changes such as temperature fluctuations, thereby maintaining optimal signal quality and reducing the risk of service degradation or interruption due to environmental factors. In some examples, by enabling dynamic adjustment of RIS configurations in response to updated interference requirements and ambient conditions, the described techniques can be used to maintain optimal signal reflection and directionality, thereby ensuring efficient use of the RIS device under varying network load and interference conditions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

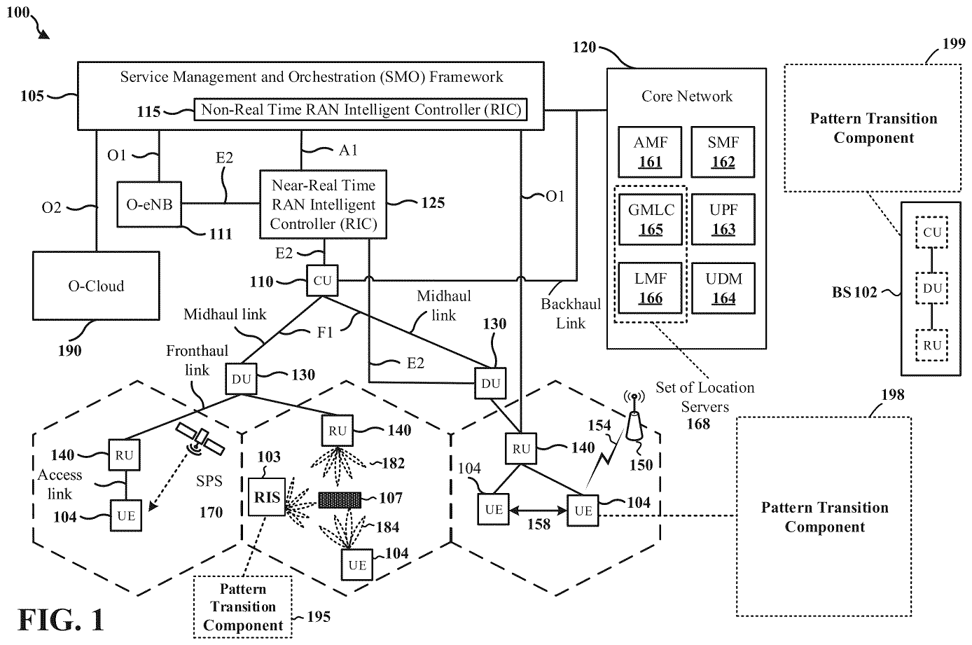

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the wireless communication system may include one or more reflective intelligent surfaces (RIS) 103, which may also be referred to by other names. A blockage 107 may occur between a network node transmitting to a UE 104 and the UE 104. The RIS 103 may include a passive antenna array with a surface with a large number of densely placed reconfigurable elements that can reflect or refract an electromagnetic wave in target directions. The RIS 103 may receive communication, e.g., from the RU 140 or the UE 104, an incident angle and reflect or transmit the communication at an angle of reflection, e.g., by controlling reflection coefficients of the antenna elements of the RIS surface, to avoid the blockage 107. The RIS 103 receives and reflects or transmits the communication without decoding the communication.

Referring again to FIG. 1, in certain aspects, the UE 104 may include the pattern transition component 198. The pattern transition component 198 may be configured to receive transition time information for two or more transitions between two or more RIS patterns in a first set of RIS patterns for an RIS device, where the transition time information for each transition of the two or more transitions is based on a change between a first RIS pattern and a second RIS pattern and a direction of the change; and communicate with the RIS device based on the first set of RIS patterns. The first set of RIS patterns is based on the transition time information. In certain aspects, the base station 102 may include the pattern transition component 199. The pattern transition component 199 may be configured to transmit, to an RIS device, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and communicate, via the RIS device, with a first UE based on the first set of RIS patterns. In some aspects, the RIS 103 may include the pattern transition component 195 configured to receive, from a network entity, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and communicate with a first UE based on the first set of RIS patterns. Although the following description may be focused on 5G NR, the concepts described herein may be applicable to other similar areas, such as LTE, LTE-A, CDMA, GSM, and other wireless technologies.

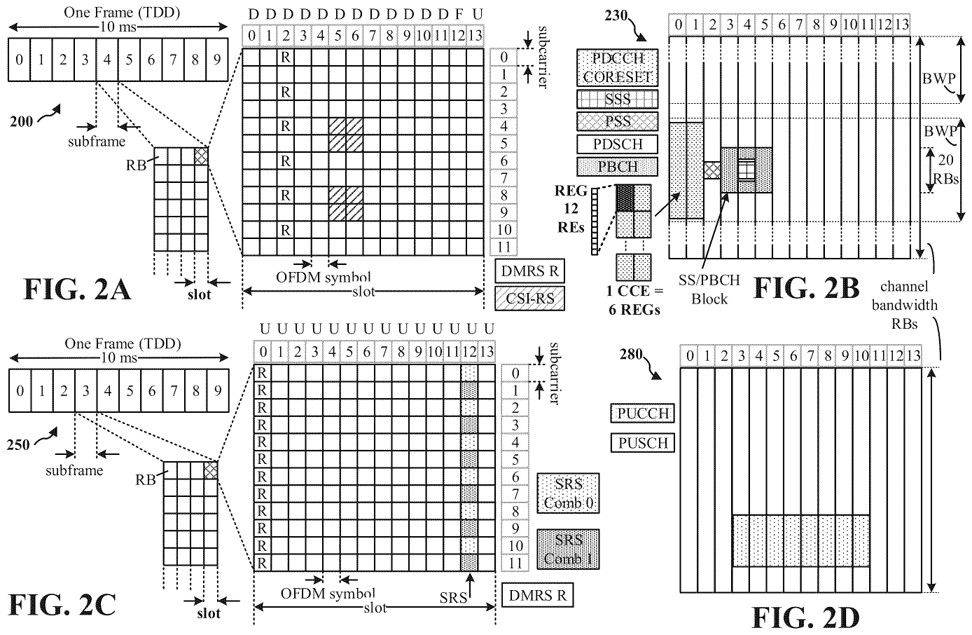

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| | Δf = 2^{μ} · 15 | |
| μ | [kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

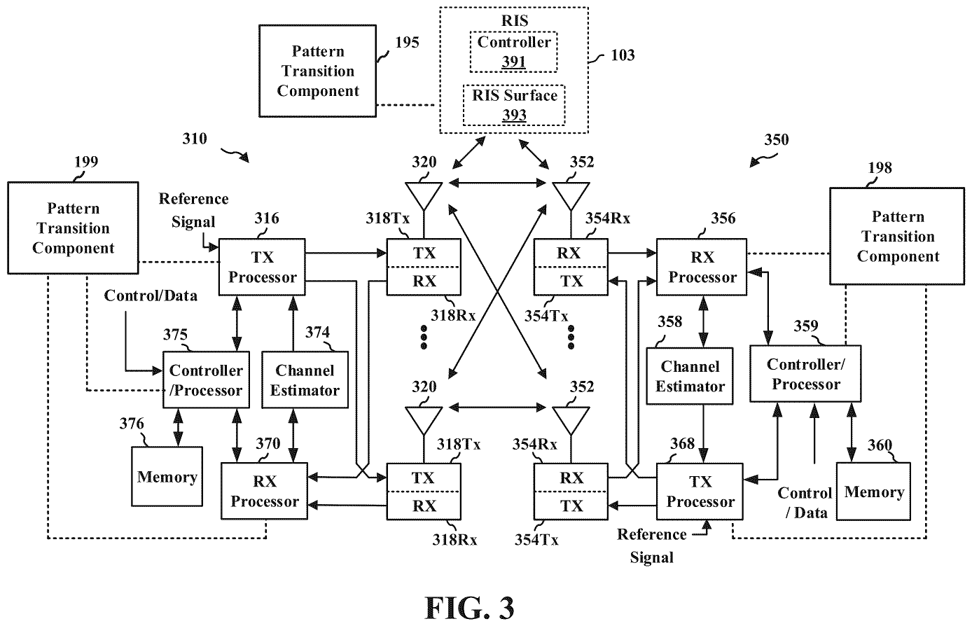

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

FIG. 3 illustrates an example of an RIS 103 that is configured to reflect communication between the base station 310 and the UE 350. The RIS 103 includes an RIS surface 393 of elements that are reconfigurable for different incident angles and reflection angles. The RIS 103 may also include a controller 391 that controls the reflection coefficients of the RIS surface 393 to adjust the angles. In some aspects, the controller 391 may include communication components, e.g., including Tx processor, and Rx processor, and/or a controller processor, such as described for the base station 310 and/or UE 350, in order to receive control signaling regarding the control of the RIS surface 393.

At least one of the TX processor 368, the RX processor 356, and the controller/processor 359 may be configured to perform aspects in connection with the pattern transition component 198 of FIG. 1.

At least one of the TX processor 316, the RX processor 370, and the controller/processor 375 may be configured to perform aspects in connection with the pattern transition component 199 of FIG. 1.

In some aspects, the RIS 103 may include the pattern transition component 195, which may be configured to perform the aspects described in connection with FIG. 1.

Beamforming gain may be achieved through the use of active antenna units. Individual RF chains may be used per antenna port. The use of active antenna units (AAU) may increase power consumption. A reconfiguration intelligent surface (RIS) may be employed to extend coverage, e.g., beamformed coverage, with reduced power consumption. The RIS may include a larger number of uniformly distributed electrically controllable elements. Each RIS element may have a reconfigurable electromagnetic characteristic, e.g., a reflection coefficient. Each RIS element may have the capability to change at least one of the properties of the incident radio waves including frequency, amplitude, phase and polarization. The radio wave may be at least reflected or transmitted to another direction after hitting the RIS panel, depending on the design of RIS. Depending on the combination of configured states of the elements, the RIS may reflect and modify the incident radio waveform in a controlled manner, for example, by changing the reflected direction or changing the beam width, etc. The specific configuration of all RIS elements of an RIS at a given time is referred to as an “RIS pattern,” which may define the overall characteristics (e.g., reflective characteristics) of the RIS at that time. The RIS may function as a near passive device, and the reflection direction may be controlled by the base station. The RIS may reflect an impinging wave in a direction indicated by the base station to a UE.

An RIS may be deployed in wireless communication systems, including cellular systems, such as LTE, NR, etc. An RIS may alter the channel realization in a controlled manner, which may improve channel diversity. The increased diversity may provide robustness to channel blocking/fading, which may be of particular importance for mmWave communication. Compared to a wireless relay or repeater systems, an RIS may be more cost and energy efficient.

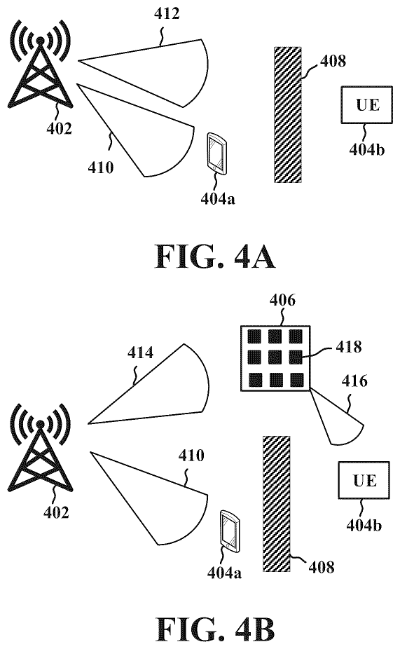

A base station may control the RIS to extend beam coverage and/or to address blockages between the base station and the UE. FIG. 4A illustrates an example in which a base station 402 transmits beamformed communication to UEs using directional beams 410, 412. A first UE 404a may be able to receive the direct transmission using the beam 410. However, FIG. 4A illustrates a blockage 408 that blocks the beam 412 from reception at the second UE 404b. As illustrated in FIG. 4B, the base station 402 may transmit communication for the second UE 404b using a directional beam 414 (which may be referred to as the impinging beam) to the RIS 406 for reflection over a directional beam 416 to the UE 404b. The base station 402 may indicate the beam direction (e.g., 416) to the RIS 406, and the RIS 406 may reflect the impinging wave on beam 414 in the direction of the beam (e.g., 416). For example, the base station 402 may determine the beam direction (e.g., 416) based on the location information of the RIS 406 and the UE 404b. The RIS may include multiple RIS elements 418 that are configured to adjust the reflected direction, the beam width, etc.

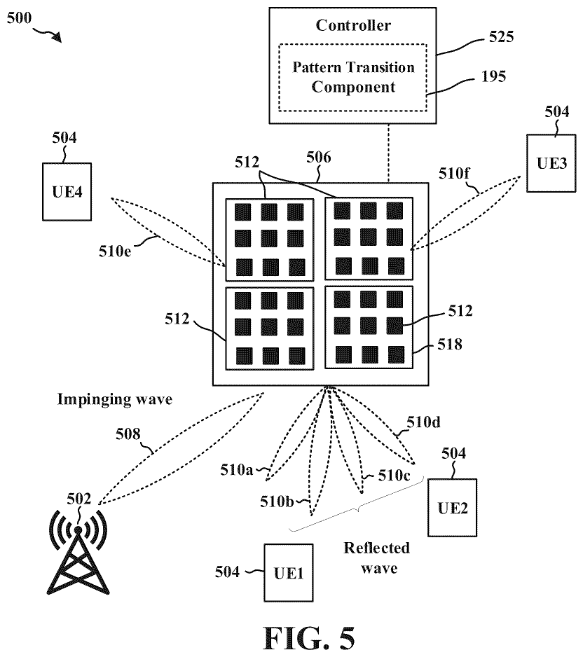

FIG. 5 illustrates an example 500 in which the RIS 506 includes multiple subsets 512 of multiple RIS elements 518. As illustrated, different subsets 512 of RIS elements 518 may serve different UEs 504. The RIS elements 518 may be controlled by a controller 525 at the RIS 506 based on control information received from the base station 502. As described in connection with FIG. 4B, the base station 502 may indicate a beam direction (e.g., any of 510a, 510b, 510c, 510d, 510e, or 510f) to the RIS for reflecting beamformed communication received as the impinging wave 508 to a particular UE 104 in a particular direction. The RIS may similarly be controlled by a UE for reflecting communication from the UE to a base station and/or to another UE. For example, the UE may determine the beam direction based on the location information of the RIS 506 and the base station 502.

The RIS may be controlled by a base station 502 and/or a UE 504, which may be referred to as the control node for the RIS. The UE and/or the base station use the RIS for communication, sensing, and/or positioning functions. RIS information may be known by a network based on network planning, and the base station may provide the RIS position and other RIS information to other nodes (e.g., UEs in the cell). For example, the base station may transmit the RIS information in system information. The UEs in the coverage of the cell may receive the system information in order to discover the presence of a RIS, the RIS position, the RIS capabilities, or other RIS information about a particular RIS. In some aspects, an RIS may be autonomously deployed by an operator or by a third-party user, e.g., and may not be a part of a planned network. In some aspects, the RIS may be mobile RIS.

An RIS device may have an array of reflecting elements, each capable of dynamic reconfiguration to control the reflection and scattering of electromagnetic waves. An RIS device may use techniques such as diodes (e.g., PIN diodes or varactor) and RF switches to achieve the reconfigurability. However, these techniques come with limitations that affect the scalability of the device. On the other hand, certain types of RIS elements, such as LC-based RIS elements, can be configured to achieve desired phase-shifts and may be used in an RIS device for wireless communication, including communication at sub-terahertz and millimeter-wave (e.g., 60 GHz) frequency ranges. In these RIS devices (e.g., LC-RIS), each codeword or pattern of the RIS device may be generated by applying a set of biasing voltages across the RIS elements. The voltage applied to each RIS element alters the permittivity of the associated layer, thereby changing its electrical length, which in turn determines the phase shift of the reflected RF signals. The response of each RIS element to voltage changes depends on various factors including the operating ambient temperature, the layer's thickness, and other material properties. Hence, the transition times for switching between different patterns of the RIS elements may vary depending on the voltages necessary to achieve the desired phase shifts between these patterns. Additionally, the transition times between different patterns are not necessarily symmetric, meaning the transition time for switching from pattern A to pattern B may be different from the transition time for switching back from pattern B to the pattern A. Example aspects presented herein provide methods and apparatus to improve the operation of RIS devices (e.g., LC-based RIS devices), including signaling and procedures such as configuration, exchange of RIS pattern transition time information and configuration of companion (second-stage) codebooks with associated pattern transition times, margins, ambient temperature information, and spatial relations, such as spatial quasi co-location (QCL) relations.

In wireless communication, such as 6G wireless communication, RIS devices have become a competitive choice to ensure ubiquitous coverage and connectivity due to their unique capabilities. An RIS device (e.g., RIS 506) includes an array of reflecting elements (e.g., RIS elements 518), each capable of dynamic reconfiguration to control the reflection and scattering of electromagnetic waves. To increase the operational footprint of a RIS, which is limited by the product path loss seen by a signal reflected via the RIS, the RIS device may have a sufficiently large aperture, and it can be desirable for this large aperture size to be achieved economically, with low-cost and low-power consumption.

In some examples, reconfigurability of an RIS device may be achieved using diodes, such as PIN diodes or varactor diodes, or using RF switches. However, each of these techniques has limitations that affect the scalability of the RIS device. For example, PIN diodes may result in substantial surface power consumption across large RIS arrays, and varactor diodes can result in higher insertion losses compared to PIN diodes and can be costlier, especially at millimeter-wave and higher frequencies. Similarly, RF switches can result in higher costs.

In some examples, certain types of RIS elements, such as LC based RIS elements, may be configured to impart the desired phase-shifts and may be used to achieve the reconfigurability of the RIS device at, for example, sub-terahertz and millimeter-wave (e.g., 60 GHz) frequencies. For example, the LC-based RIS elements with a relatively thin LC layer (e.g., measuring 4.6 μm, as an example) may be used to achieve not only good bandwidth but also reconfigurability in a matter of tens of milliseconds. Hence, LC-based RIS devices may offer the combination of benefits of being low-cost, having low-power consumption, and supporting large RIS arrays with the potential for sub-millisecond reconfigurability.

Unlike other types of the RIS devices (e.g., RIS devices based on PIN or varactor diodes), LC-based RIS devices may have larger and asymmetric pattern transition times. Compared to mechanical rotation-based RIS, LC-based RIS devices' transition times are voltage-dependent, which allows for finer optimization that is not feasible with non-voltage dependent RIS. Additionally, LC-based RIS devices are more sensitive to changes in operating ambient temperatures compared to other types of RIS devices (e.g., RIS devices based on PIN or varactor diodes). Based on these characteristics of the RIS devices (e.g., LC based RIS devices), example aspects presented herein provide signaling mechanisms, procedures, and configurations to facilitate the efficient operations of the RIS devices (e.g., LC based RIS devices). These include the configuration and exchange of information on RIS pattern transition times (e.g., pattern transition time tables), which may be used for optimizing the beam-sweep order and adjusting the serving order of users in burst communication. As used herein, a “burst” or “burst communication” refers to the transmission of data packets or signals in rapid, short, intense intervals or a data packet to one or more recipients.

Additionally, example aspects presented herein provide the configuration of companion codebooks (or second-stage codebooks, stage-2 codebooks) with associated pattern transition times, margins, ambient temperature information, and spatial relations, such as spatial QCL relations. This allows the RIS configurations to be adjusted based on the changes in ambient temperature and updated interference conditions on the reflected beam by utilizing the information on refinement patterns and transition times. In some examples, the configured grant resource allocation may be improved, or optimized, based on information on refinement patterns and transition times. Example aspects presented herein may use LC-based RIS devices as an example to illustrate the proposed methods and apparatus. However, the described techniques are not limited to LC-based RIS devices and may be applicable to other types of RIS devices.

In some examples, in LC-based RIS devices, each codeword or pattern may be achieved by applying a set of biasing voltages across the elements (e.g., all elements) of the LC-RIS device. The voltage applied to each LC-RIS element may change the permittivity of the associated LC layer, thereby changing its electrical length, which in turn determines the phase shift of the reflected RF signals.

In some examples, the response of each LC-RIS element to voltage changes may be determined by a differential equation, with underlying parameters depending on various factors including the operating ambient temperature, the LC layer's thickness, and other material properties.

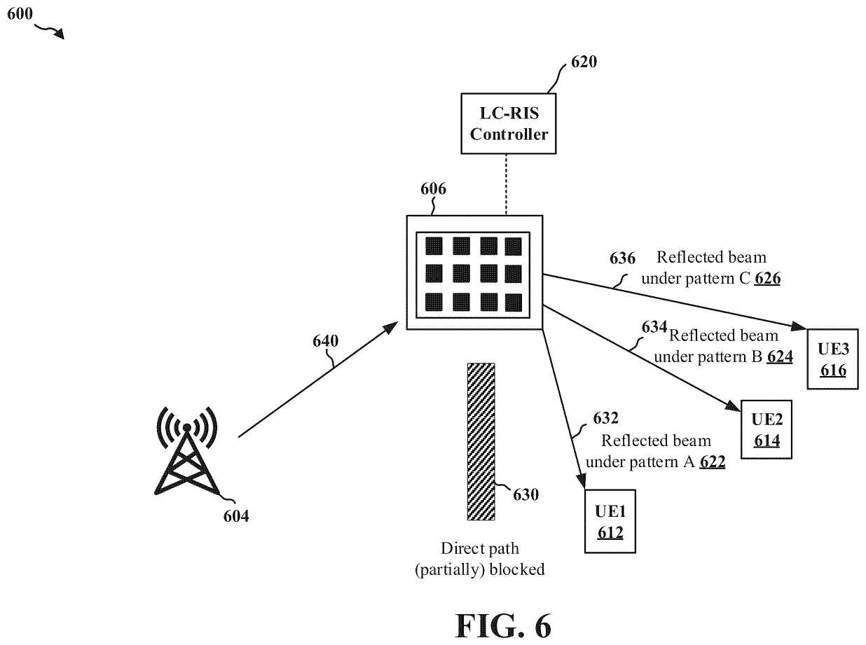

FIG. 6 is a diagram 600 illustrating an example operation of an RIS device. As shown in FIG. 6, a base station 604 may communicate with one or more UE (e.g., UE 1 612, UE 2 614, and UE 3 616) via an RIS device 606, as the direct communication between the base station 604 and the UE is blocked by the obstacle 630. The RIS device 606 may apply different RIS patterns (e.g., pattern A 622, pattern B 624, pattern C 626), so that the incident wave 640 from the base station 604 may be respectively reflected (e.g., via 632, 634 636) towards the one or more UE (e.g., UE 1 612, UE 2 614, and UE 3 616). In some examples, the RIS device 606 may be an LC-based RIS device. In some examples, the RIS pattern applied on the RIS device 606 may be controlled by the RIS controller 620. The transition from one pattern to another, such as from pattern A 622 to pattern B 624, may take a certain amount of time, which may be referred to as the “transition time.” That is, the transition time may refer to the time for each of the elements of the RIS device to assume its new configuration (for a new RIS pattern) after the reconfiguration is instructed or activated. The transition time may vary depending on the voltages necessary to achieve the desired phase shifts between these patterns. In some examples, this transition time between different patterns may vary significantly, e.g., in the order of a few milliseconds. In some examples, analog control techniques such as undershoot and overshoot may reduce the transition times, yet may do so at the cost of increased controller power consumption. The transition times in the LC-based RIS devices may be asymmetric, e.g., direction dependent. For example, the transition time for switching from pattern A 622 to pattern B 624 may differ from (e.g., longer than or shorter than) the transition time it takes to switch from pattern B 624 back to pattern A 622.

In some aspects, a pattern transition time (PAT) table may be used to convey the transition time information for multiple transitions that may be performed by an LC-based RIS. In some examples, for each base station that can control an LC-based RIS (e.g., the base station 502, 604), the operations and maintenance (OAM) may configure a unique PAT table. In some examples, a management entity (e.g., a third-party management entity) may instruct the LC-based RIS to download a PAT table, for example, from cloud storage. The PAT table may enumerate the transition times for switching between at least one RIS pattern (e.g., pattern A 622) to at least one another RIS pattern (e.g., pattern B 624), e.g., which may be indicated for a particular direction of the transition (e.g., from pattern A or pattern B or from pattern B to pattern A). The transition time for a transition between one set of patterns may be different than the transition time between a different set of patterns. Thus, the PAT may include transition times for each transition of a set of multiple transitions. In some examples, the RIS patterns may be determined by, or selected by, the controlling base station, such as base station 502, 604, because the controlling base station is the transmitter illuminating the RIS in the downlink. Therefore, in some aspects, the PAT table may be specific to a particular base station. For example, each controlling base station may have or receive a separate PAT table or a base station specific PAT table.

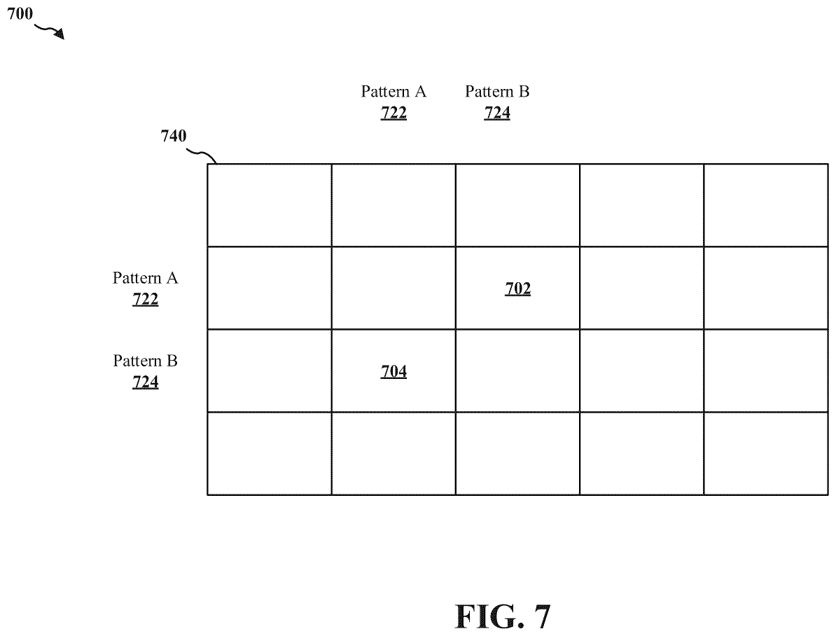

FIG. 7 is a diagram 700 illustrating an example PAT table 740 in accordance with various aspects of the present disclosure. As shown in FIG. 7, in some examples, one or more entries (e.g., entry 702) of a PAT table 740 may correspond to a pair of patterns, such as pattern A 722 and pattern B 724. In some examples, one entry of the PAT table 740 (e.g., entry 702) may identify and provide the transition time needed to change the RIS configuration from pattern A entry (e.g., 722) to pattern B entry (e.g., 724), and another entry (e.g., entry 704) may identify and provide the transition time to change the RIS configuration from pattern B 724 back to pattern A 722.

In some examples, the PAT table 740 may include entries for both of these transition times (e.g., the transition times for switching from pattern A to pattern B and from pattern B to pattern A) under a fast mode, or faster mode. The “fast mode” may be an operation setting of the RIS device that accelerates the switching process, potentially leading to higher power consumption by the RIS controller. Compared to the fast mode, the other operation setting, in which the switching speed is not increased, may be referred to as a “regular mode.” For example, the entry 702 in the PAT table 740 may include two transition times for changing the RIS configuration from pattern A entry (e.g., 722) to pattern B entry (e.g., 724), one for the time under the “regular mode,” and the other for the time under the “fast mode.” The two modes may be referred to by other names, such as a first mode and a second mode, where the second mode involves a faster switching process than the first mode.

In some examples, the transition times included in the PAT table may be specified or indicated in any of various units, including time units such as tens of microseconds or milliseconds. In other examples, the transition times may be indicated with a unit of orthogonal frequency division multiplexing (OFDM) slots or symbols, e.g., which may be as a function of the sub-carrier spacing (SCS).

In some aspects, patterns of an RIS device (e.g., the RIS patterns) may be divided into multiple groups (e.g., N groups). Within these N groups, the pattern switch latency for switching between patterns within the same group (e.g., the intra-group transition time) may be represented by a first value (e.g., T₁), whereas the pattern switch latency (e.g., transition times in the PAT table) for switching between patterns in different groups (e.g., the inter-group transition time) may be represented by a common value T₂. In some examples, a set of values (e.g., T₂ {i,j}, where i and j represent the indices of the groups to which the two involved patterns belong) may represent the transition time for switching from one pattern in group i to one pattern in group j.

In some examples, a fixed or common switch time (or transition time) between RIS patterns may be configured or indicated. As an example, the fixed or common switch time may be based on statistical information such as the mean, the median, the minimum, or the maximum of observed switch times (or transition times). The actual transition times for different pattern transitions may then be represented (e.g., in the PAT table) as an indicated offset, or delta, with respect to this common switch time (or transition time). The indicated offsets may reflect the variations in individual switch times (or transition times) relative to the common/fixed switch time.

In some examples, the set of RIS patterns may be divided into one or more ordered subsets, where the RIS patterns within each of the subsets are arranged in a specified order. For each ordered subset of RIS patterns, combined transition times may be indicated for a combination of multiple transition times. For example, one of the two combined transition times may represent the total transition time for a sweep or traversal from the lowest to the highest pattern indices (e.g., left to right sweep), and another of the combined transition times may represent the total transition time for a sweep or traversal in the other direction from the highest to the lowest pattern indices (e.g., right to left sweep).

In some examples, the actual transition may settle (e.g., complete and be ready for reflection of communication based on the new pattern) faster than the times listed in a table, such as the PAT table, due to the drifts or quantized nature of table entries. In some aspects, the PAT table may be referred to as a look-up table (LUT). In some aspects, analytical formulas used to determine these transition times may not always be precise due to their approximate nature. In some examples, this error can be comparable to available signaling granularity. To manage this variability, in some examples, if the nature of the transition time drift is more deterministic or static, the LUT (e.g., the PAT table) may periodically be updated or recalibrated. For example, the record of the transition times (e.g., the LUT/PAT table) may be updated periodically, or a calibration phase may be conducted during the setup to create the collection of transition times (e.g., LUT/PAT). The “setup” process may include the installation process of an LC-based RIS. In some examples, the record of the transition times (e.g., the LUT/PAT table) may be obtained, for example, in a factory or laboratory setting. In some examples, if the drift is more random or dynamic, such as those caused by factors like LC molecule re-orientation randomness, a more dynamic method may be used to adjust or update the indicated switch latency (or transition time). For example, a base station may indicate a new configuration to an LC-based RIS device (LC-RIS), assuming that it takes a certain transition time (e.g., X millisecond (or msec)) for the LC-based RIS device to switch to the new configuration from its current configuration. If the actual transition achieved by the LC-RIS controller is faster (e.g., Y msec, where X>Y), the LC-RIS controller may send a message (e.g., a “ready” message) to the controlling base station using a designated signal, indicating that the LC-RIS device is ready to apply the new pattern (or configuration) and the switch is completed sooner than anticipated.

In some aspects, when the LC-RIS can operate under different operational modes or settings, such as the “fast mode” or “regular mode,” or a “first mode” and “second mode.” The LC-RIS controller, or OAM, may inform the network about the energy costs associated with these different operational modes or settings. This information helps the network in making decisions to choose a proper operational mode or setting to balance energy consumption, latency, and performance effectively.

In some aspects, as the number of RIS devices deployed in a network (e.g., in a network cell) grows, the base station may face scalability challenges if it tries to control each RIS directly. In this case, the base station may choose to relinquish control of one or more RIS devices to a UE. In such scenarios, the base station may transmit the codebook patterns, configuration information, and parameters related to transition times (e.g., the PAT table) to the UE, and the UE may configure the RIS pattern for the RIS devices based on the information received from the base station. In some examples, the base station or network node (e.g., network cell) may configure the UE to download this information or can communicate it through explicit signaling.

In some aspects, instead of providing a potentially large collection of transition times for changes between patterns (e.g., a large LUT or PAT table) that includes numerous transitions times for the transitions within and across codebook patterns, one or more common “maximum” transition times may be defined, configured, or identified, for one or more groups of RIS patterns, and the LC-RIS controller may send back a message (e.g., a “ready” message) to the base station once an indicated transition is complete (e.g., within the maximum transition time). In some examples, this signaling mechanism may be used for dynamic schedules to allow efficient communication of the transition time information. In some examples, this signaling mechanism may be used on more static or periodic scheduling such as those using synchronization signal block (SSB) or configured grant physical uplink shared channel (CG-PUSCH).

In some aspects, the OAM may configure some parameters and establish rules for the base station, which may be passed on to the UE, if necessary. These parameters and rules may determine a minimum transition time for any intended pattern switch. Then, the time window during which the base station should be prepared to receive a potential message from the LC-RIS controller, indicating readiness to use the new configuration or pattern (e.g., the “ready” message), may be constrained to a range defined by, or based on, the minimum and maximum transition times. This approach effectively shortens the time window, ensuring faster responsiveness while improving energy efficiency at both the base station and UE by minimizing unnecessary waiting times and power consumption.

In some aspects, the order of beam sweeps (e.g., SSB beam sweeps) on an LC-based RIS device may be improved by utilizing the transition time information. For example, the LC-based RIS device may perform the RIS pattern transitions that are time-aligned with beam switching in the beam sweeping. In the example of beam sweeping, the RIS pattern transitions being “time-aligned” with beam switching means that the beam switching is achieved with the transitions of different RIS patterns, such that the timing of applying a new beam coincides with the timing of applying a new RIS pattern. In some beam sweep methods, the order of beams used in the beam sweep for a given set of beams does not significantly impact the performance. However, in beam sweep with an LC-based RIS device, the order in which beams are swept in a given set of beams becomes important due to the specific transition times between different RIS patterns.

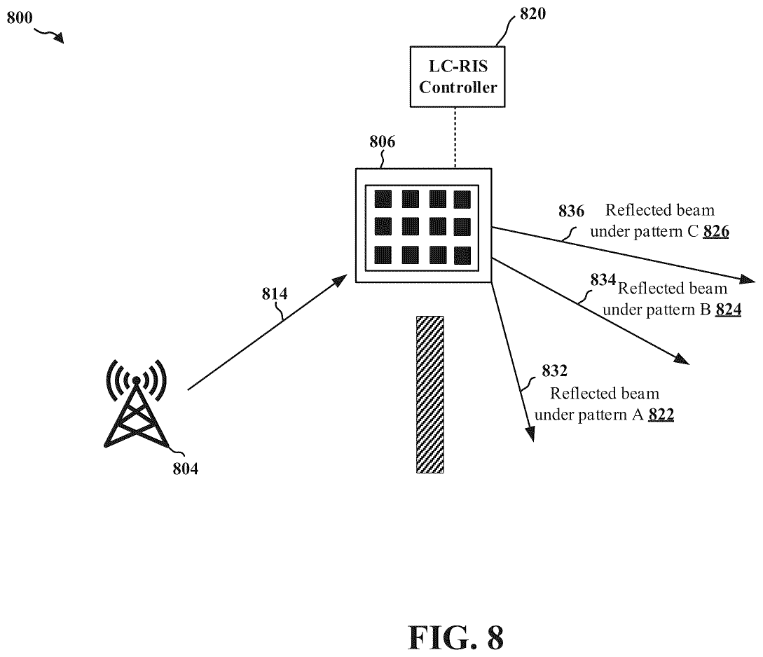

FIG. 8 is a diagram 800 illustrating an example beam sweeping process using an RIS device. As shown in FIG. 8, a base station 804 may perform a beam sweeping process via an RIS device 806 by transiting one or more transmissions 814 to the RIS device 806. During the beam sweeping process, the RIS device 806 may apply different RIS patterns (e.g., pattern A 822, pattern B 824, pattern C 826) to achieve different reflected beams (e.g., at 832, 834, 836). Hence, the transitions of different RIS patterns (e.g., pattern A 822, pattern B 824, pattern C 826) are time-aligned with the switching of different reflected beams (e.g., at 832, 834, 836). As shown in FIG. 8, in an example beam sweep that transitions through pattern A 822, pattern B 824, and pattern C 826, if the beam sweep order is from pattern A 822 to pattern B 824, and then to pattern C 826, the total transition time is the sum of the transition times it takes to switch from pattern A 822 to pattern B 824, and from pattern B 824 to pattern C 826. On the other hand, if the beam sweep order is from pattern B 824 to pattern A 822 and then to pattern C 826, the total transition time is the sum of the transition times it takes to switch from pattern B 824 to pattern A 822 and from pattern A 822 to pattern C 826. These two total transition times may differ significantly (e.g., in the order of a few milliseconds) due to the different underlying voltages needed to realize the respective patterns.

In some aspects, the order of beam sweeps may be improved or optimized by utilizing information on pattern transition times (e.g., transition time information based on the PAT table 740) for parameters used in the beam sweeps. In some examples, the order of beam sweeps may be improved or optimized to reduce the time duration the RIS device takes to sweep across all RIS patterns.

Additionally, optimizing the beam sweep order may not only be beneficial during normal operation of RIS devices but may also be beneficial to random access channel (RACH) occasions. For example, in cases where an SSB beam sweep is used, the LC-RIS device (e.g., RIS device 806) may maintain the pattern associated with an SSB beam during its corresponding RACH occasion. Therefore, the benefits of optimized beam order (e.g., reduced time duration to sweep across the RIS patterns) can also extend to RACH occasions.

In some aspects, optimizing or improving the beam sweep order based on the transition time information (e.g., the PAT table 740) may provide additional benefits beyond, or instead of, reducing the time duration to sweep across the RIS patterns. For example, a network base station (or a network cell), such as base station 804, may have a fixed set of resources available for sweeping its signals (e.g., SSB, reference signal measured signal indication (RMSI), physical random access channel (PRACH), and paging signals) in, for example, a given SSB burst pattern. In this case, the selection of which resources within the burst to be used for the LC-RIS device (e.g., RIS device 806) to sweep its patterns (e.g., pattern A 822, pattern B 824, pattern C 826), and the associated pattern for each selected resource may be done based on the unique and asymmetric transition times of each pattern. In some examples, the LC-RIS controller (e.g., RIS controller 820) or OAM may suggest the selection of those resources to the base station (or network cell), such as base station 804. For example, the order of beams in the beam sweep may be selected to minimize or reduce the time for the beam sweep (such as by minimizing or reducing the transition time between individual patterns (corresponding to beams) or by minimizing or reducing the combination of transition times for the beam sweep pattern).

In some aspects, the order of burst patterns in burst communication via an LC-based RIS device may be improved by utilizing the transition time information. In some burst-based data communications, the sequence in which users are served within a burst does not consider the transition times between different beam patterns. However, in burst communication using an LC-based RIS device, the order in which the RIS patterns in a given set of RIS patterns are arranged and utilized may significantly impact the efficiency of the burst communication based on the different transition times between various patterns. For example, the LC-based RIS device may perform the RIS pattern transitions that are time-aligned with the burst communication, meaning that the switching of the served users is achieved with the transitions of different RIS patterns, such that the timing of switching a served user coincides with the timing of applying a new RIS pattern.

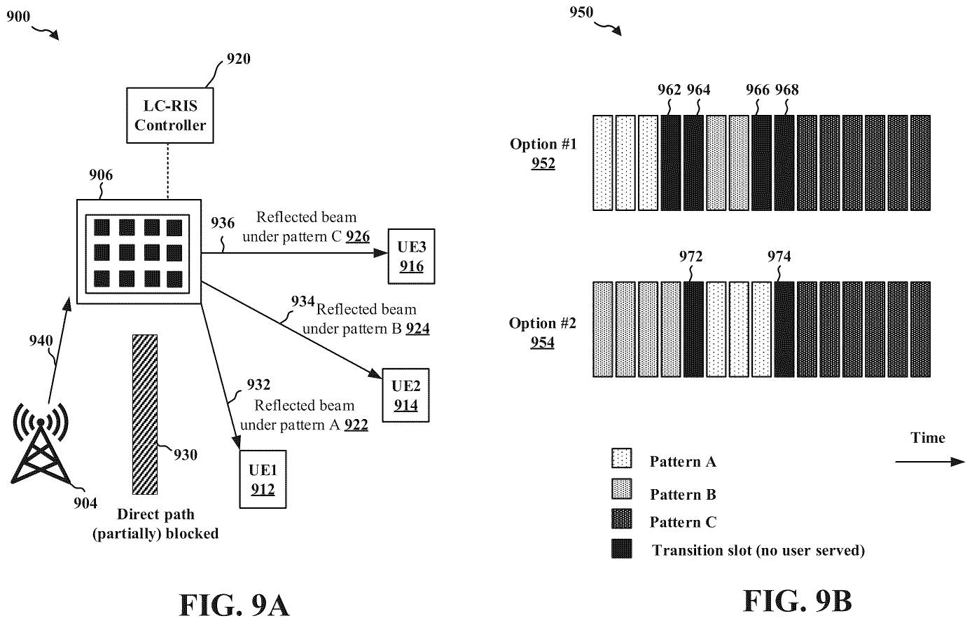

FIG. 9A is a diagram 900 illustrating an example of burst communication with multiple users via an RIS device in accordance with various aspects of the present disclosure. As shown in FIG. 9A, a base station 904 may communicate with multiple users (e.g., UE 1 912, UE 2 914, and UE 3 916) in burst communication via an RIS device 906, as the direct communication between the base station 904 and the users may be blocked by the obstacle 930. As illustrated, the RIS device 906 may have an LC-RIS controller 920. The RIS device 906 may apply different RIS patterns (e.g., pattern A 922, pattern B 924, pattern C 926), so that the incident wave 940 from the base station 904 may be respectively reflected (e.g., via 932, 934, 936) towards the multiple users (e.g., UE 1 912, UE 2 914, and UE 3 916) to realize the burst communication. Hence, the transitions of different RIS patterns (e.g., pattern A 922, pattern B 924, pattern C 926) are time-aligned with the switching of the users (e.g., UE 1 912, UE 2 914, and UE 3 916). In some examples, the RIS device 906 may be an LC-based RIS device.

In the example of burst communication shown in FIG. 9A, three users (e.g., UE 1 912, UE 2 914, and UE 3 916) may be served in a specific order (e.g., a burst order). FIG. 9B is a diagram 950 illustrating different orders of serving multiple users in burst communication via an RIS device in accordance with various aspects of the present disclosure. As shown in FIG. 9A and FIG. 9B, in one example (e.g., option #1 952), the burst order may include user A (e.g., UE 1 912) with pattern A 922, followed by user B (e.g., UE 2 914) with pattern B 924, and then user C (e.g., UE 3 916) with pattern C 926. In this case, the total transition time is the sum of the transition time it takes to switch from pattern A 922 to pattern B 924, which may span slots 962 and 964, and the transition time from pattern B 924 to pattern C 926, which may span slots 966 and 968. In another example (e.g., option #2 954), the burst order may include user B (e.g., UE 2 914) with pattern B 924, followed by user A (e.g., UE 1 912) with pattern A 922, and then user C (e.g., UE 3 916) with pattern C 926. In this case, the total transition time is the sum of the transition time it takes to switch from pattern B 924 to pattern A 922, which may span slot 972, and the transition time from pattern A 922 to pattern C 926, which may span slot 974. As shown in FIG. 9B, these two total transition times may differ significantly (e.g., in the order of a few milliseconds), depending on the underlying voltages needed to realize the respective patterns.

In some aspects, the order of serving users (e.g., UE 1 912, UE 2 914, and UE 3 916) in burst communication may be improved by utilizing information on pattern transition times for the patterns involved (e.g., based on the PAT table 740). In some examples, the order of serving users in burst communication may be improved or optimized to reduce the total time duration to serve all users in the burst communication or improve throughput for the same duration, thereby enhancing the overall quality of service (QoS).

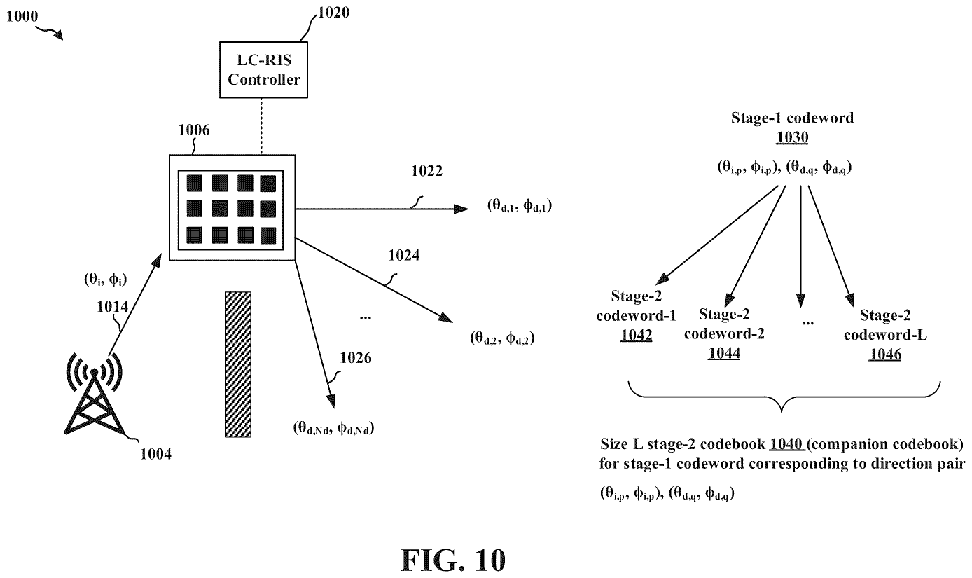

In some aspects, a codebook for an RIS device may include multiple codewords, and each codeword in the codebook may represent a specific RIS configuration or pattern (e.g., pattern A 922, pattern B 924, pattern C 926). FIG. 10 is a diagram 1000 illustrating example codewords for an RIS device 1006 that exchanged communication with a base station 1004, in accordance with various aspects of the present disclosure. The RIS device 1006 may have a controller 1020. As shown in FIG. 10, each codeword may correspond to a particular combination of incident direction (e.g., θᵢ, Øᵢ) at 1014 and reflected direction (e.g., θ_{d}, Ø_{d}) at, for example, 1022, 1024, 1026. In some examples, the codewords in the codebook may not be associated with each other (e.g., no spatial quasi co-location (QCL) relation between the codewords and the corresponding reflect beams may point towards significantly different directions (e.g., the angle difference between the reflected beams is greater than an angle threshold)), and such a codebook may be referred to as a “stage-1” codebook. Accordingly, the codewords in a “stage-1” codebook may be referred to as “stage-1” codeword.

As shown in FIG. 10, an RIS device may support Nᵢ different incident directions in

$$I = \{ ( {θ}_{i , 1} , {∅}_{i , 1} ) , ( {θ}_{i , 2} , {∅}_{i , 2} ) , … , ( {θ}_{i , {N}_{i}} , {∅}_{i , {N}_{i}} ) \} \qquad ( 1 )$$

and N_{d} different reflected directions in

$$D = \{ ( {θ}_{d , 1} , {∅}_{d , 1} ) , ( {θ}_{d , 2} , {∅}_{d , 2} ) , … , ( {θ}_{d , {N}_{d}} , {∅}_{d , {N}_{d}} ) \} \qquad ( 2 )$$

The number of codewords in the codebook for this RIS device 1006 may be Nᵢ×N_{d}.

In some aspects, for every codeword (e.g., every stage-1 codeword) in the stage-1 codebook, which may correspond to the incident direction (e.g., θᵢ, Øᵢ) and the reflected direction (e.g., θ_{d}, Ø_{d}), at least one corresponding stage-2 codebook including one or more companion codewords may be provided. A stage-2 codebook may also be referred to as a “companion codebook” or “refinement codebook,” and a companion codeword may be referred to as a “stage-2” codeword or “refinement codeword” of the corresponding “stage-1” codeword.

In some examples, each codeword (e.g., stage-2 codeword) in the companion codebooks (e.g., stage-2 codebooks) may have a reflected beam similar to its associated stage-1 codeword, connected via a spatial relation (e.g., a spatial QCL relation). In some examples, each stage-2 codeword may offer a gain (within a given margin) for the wave incident along the incident direction of (θᵢ, Øᵢ) and towards the target reflected direction of (θ_{d}, Ø_{d}). However, the gains along different non-target reflected directions may vary significantly.

In some aspects, for an LC-based RIS device, the stage-2 codebooks for a stage-1 codebook may be developed based on the transition time information. In some aspects, the stage-1 codewords and any of its companion codewords (e.g., stage-2 codewords) may be realized via different corresponding voltage levels. Therefore, the transition times between two stage-1 codewords may be considerably different than those between any of their respective companion codewords (e.g., stage-2 codewords). To accommodate various operational needs, multiple stage-2 codewords may be specified for a stage-1 codeword, and each of these stage-2 codewords may correspond to a different gain margin. For example, as shown in FIG. 10, multiple stage-2 codewords (e.g., stage-2 codewords 1042, 1044, 1046) may be specified for a stage-1 codeword 1030, and each of these stage-2 codewords may correspond to a different gain margin. All these stage-2 codewords (e.g., stage-2 codewords 1042, 1044, 1046) may be connected through the spatial relation (e.g., spatial QCL relation) to the common stage-1 codeword 1030. In some examples, two patterns corresponding to two different stage-2 codewords that are within a gain margin (e.g., X dB and Y dB, respectively) of the common stage-1 codeword 1030 may be referred to as being mutually associated with each other.

In some aspects, in the deployment of LC-based RIS device, the selection of the companion codewords for each codeword (e.g., stage-1 codeword) in a stage-1 codebook may be adapted to account for changes in environmental conditions, such as the temperature variations.

In some examples, the sensitivity of LC-RIS to operating temperatures may significantly affect the response to applied voltages. As a result, for a given set of applied voltages, the reflected beam may drift and become mismatched as temperatures vary.

To address this issue, one or more temperature-indexed companion codebooks may be provided for each codeword (e.g., stage-1 codeword) in a stage-1 codebook. These companion codebooks may include codewords (e.g., companion codewords) that are connected through the spatial relation (e.g., spatial QCL relation) to the common stage-1 codeword, ensuring that all the companion codewords correspond to directions that point approximately to the same target location despite different operational temperatures. In some examples, the voltage sets used to realize these companion codewords in these companion codebooks may be distinct and each voltage set may be specifically tailored to accommodate the LC-RIS's response at a different operating temperature.

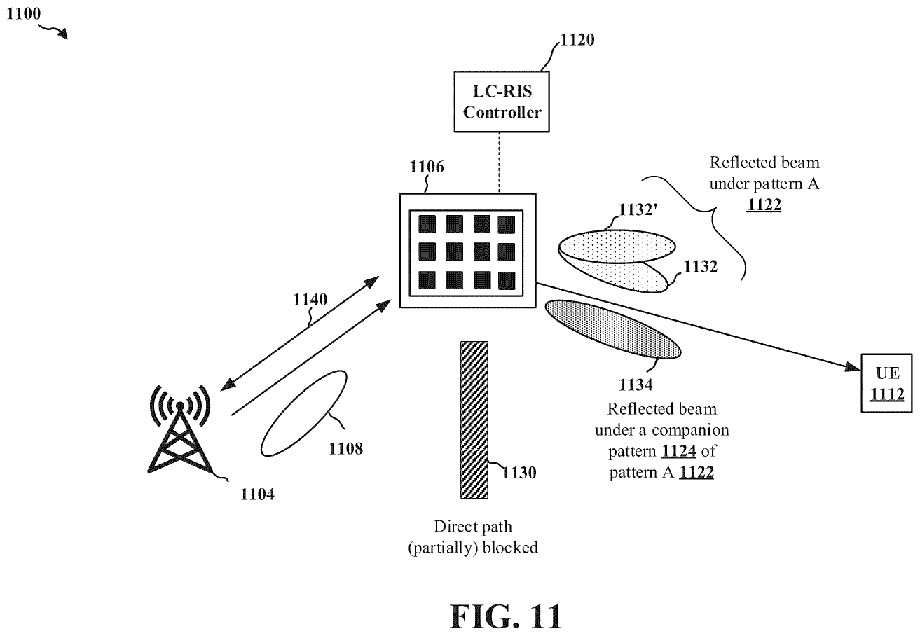

FIG. 11 is a diagram 1100 illustrating an example of using companion codewords in an RIS device in response to temperature changes in accordance with various aspects of the present disclosure. As shown in FIG. 11, a base station 1104 may communicate with UE 1112 via an RIS device 1106, e.g., to avoid a blockage 1130. During the setup process at 1140, the base station 1104 and the RIS controller 1120 may exchange two-stage codebook information (e.g., stage-1 codeword 1030 and the associated stage-2 codebook 1040) along with LC-RIS transition time table (e.g., PAT table 740). Initially, the RIS device 1106 may use pattern A 1122 for communication with the base station 1104 and UE 1112. The pattern A 1122 may correspond to an incident direction of incident beam 1108 and a reflected direction of reflected beam 1132. The beam 1108 (or the main lobe of the base station 1104) may be steered towards the RIS device 1106. The reflected direction of reflected beam 1132 may have a good directivity towards the UE 1112 under the current condition (e.g., current temperature).

As the operating condition (e.g., the temperature) changes, the reflected beam 1132 may drift (e.g., to beam 1132′) and become mismatched with the UE 1112. In this case, one or more temperature-indexed companion codebooks may be provided for each codeword (e.g., stage-1 codeword) in a stage-1 codebook, and the RIS device 1106 may switch to a proper companion codeword (e.g., companion codeword (e.g., 1124) corresponding to beam 1134) based on, for example, the temperature, to maintain the acceptable directivity of the communication between the RIS device 1106 and UE 1112.

In some aspects, the switch to a companion codeword may be triggered by some trigger events indicating that the current LC-RIS pattern has become mismatched. In some examples, upon the occurrence of a trigger event, the base station 1104 may obtain temperature readings of the LC-RIS array (e.g., RIS device 1106) or its ambient environment by, for example, querying the RIS controller 1120 or receiving updates directly from a network node in a periodic manner. Based on these temperature readings, the base station then may instruct the LC-RIS controller 1120 to switch the LC-RIS array to an alternate pattern in a stage-2 codebook (companion codebook) associated with the current codeword (e.g., the current stage-1 codeword) and the current ambient temperature. This alternate pattern (refinement pattern, or companion codeword (e.g., 1124)), selected from the stage-2 codebook (companion codebook), may be associated with the current codeword (e.g., the current stage-1 codeword) and belongs to a stage-2 codebook of an acceptable margin.

In some examples, the time needed for the transition from the current codeword (e.g., corresponding to pattern A 1122) to the alternate one (e.g., companion codeword (e.g., 1124)) may be obtained based on the transition time information (e.g., the PAT table 740) and may be verified to be within an acceptable range before the transition. In some examples, the time for the transition may be indexed by the temperature to account for temperature variations.

In some examples that involve the deployment of LC-based RIS, it may not be necessary to explicitly indicate the temperature readings for the proper selection of codewords. Instead, the LC-RIS controller 1120 may (e.g., based on an instruction) map the temperature readings to an index, such as an index or identifier of a specific codebook or associated updated switch times between patterns in that codebook. Then, the LC-RIS controller 1120 may exchange (e.g., periodically exchange) this selected index based on inquiries from the network or in response to event-triggered changes in temperature. This approach allows RIS configurations to adapt autonomously to temperature variations.

In some aspects, the RIS controller (e.g., LC-RIS controller 1120), OAM, or network node (e.g., base station 1104) may utilize coarse or historical temperature data or information to predict patterns of temperature fluctuation in a day. For example, based on these patterns, a day may be divided into multiple time intervals, each with relatively stable temperature ranges. Then, some reconfigurations for the RIS device (e.g., RIS device 1106), such as selecting the appropriate codebook or assumption of the switch times, may be performed autonomously, without the need for frequent signaling exchanges.

In some aspects, in the deployment of LC-based RIS device, the selection of the companion codebooks for each codeword (e.g., stage-1 codeword) in a stage-1 codebook may be adapted to account for changes in interference conditions for reflected beams.

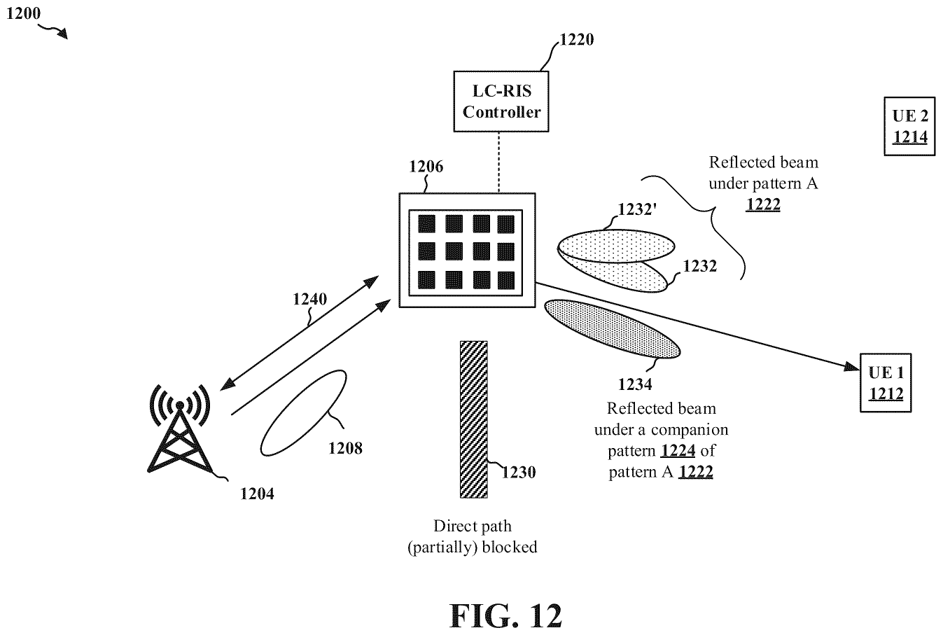

FIG. 12 is a diagram 1200 illustrating an example of using companion codewords in an RIS device in response to changes in interference conditions in accordance with various aspects of the present disclosure. As shown in FIG. 12, a base station 1204 may communicate with UE 1 1212 via an RIS device 1206, e.g., to avoid a blockage 1230. During the setup process at 1240, the base station 1204 and the RIS controller 1220 may exchange two-stage codebook information (e.g., stage-1 codeword 1030 and the associated stage-2 codebook 1040) along with LC-RIS transition time table (e.g., PAT table 740). Initially, the RIS device 1206 may use pattern A 1222 for communication with the base station 1204 and UE 1 1212. The pattern A 1222 may correspond to an incident direction of incident beam 1208 and a reflected direction of reflected beam 1232. The beam 1208 (or the main lobe of the base station 1204) may be steered towards the RIS device 1206. The reflected direction of reflected beam 1232 may have a good directivity towards the UE 1212 under the current condition. However, the good directivity towards the desired UE 1 1212 may impact the operation of UE 2 1214. For example, UE 2 1214 may be impacted by the side lop 1232′.

In this case, the network node (e.g., base station 1204) may indicate the LC-RIS controller 1220 to switch the RIS array to an alternate pattern (e.g., refinement pattern 1224 corresponding to beam 1234) in a stage-2 codebook associated with the current codeword (e.g., a stage-1 codeword). In some examples, the alternate pattern (corresponding to a stage-2 codeword), which the LC-RIS controller switches to, may be associated with the current codeword (e.g., stage-1 codeword) and also belong to a stage-2 codebook associated with the current codeword (e.g., stage-1 codeword) and has an acceptable margin (e.g., an acceptable gain margin). Additionally, the selected alternate pattern (e.g., refinement pattern 1224) may satisfy the necessary leakage constraints (e.g., the leakage associated with the refinement pattern 1224 is below a leakage threshold) to mitigate the interference (e.g., the interference to UE 2 1214).

In some aspects, the selection of the alternate pattern (e.g., refinement pattern 1224) may take into consideration the time needed to make this transition (e.g., the transition time information), which may be determined by the information available in the PAT table (e.g., PAT table 740), as an example. For example, the transition time associated with the alternate pattern (e.g., refinement pattern 1224) should be within an acceptable range to avoid any disruption in service or performance degradation.

In some aspects, in the deployment of LC-based RIS device, the configured grant operations may be performed considering the transition time information of the RIS device. For example, the LC-based RIS device may perform the RIS pattern transitions that are time-aligned with the configured grant operations, means that the switching of the users with respect to the configured grant is achieved with the transitions of different RIS patterns, such that the timing of switching a user coincides with the timing of applying a new RIS pattern.

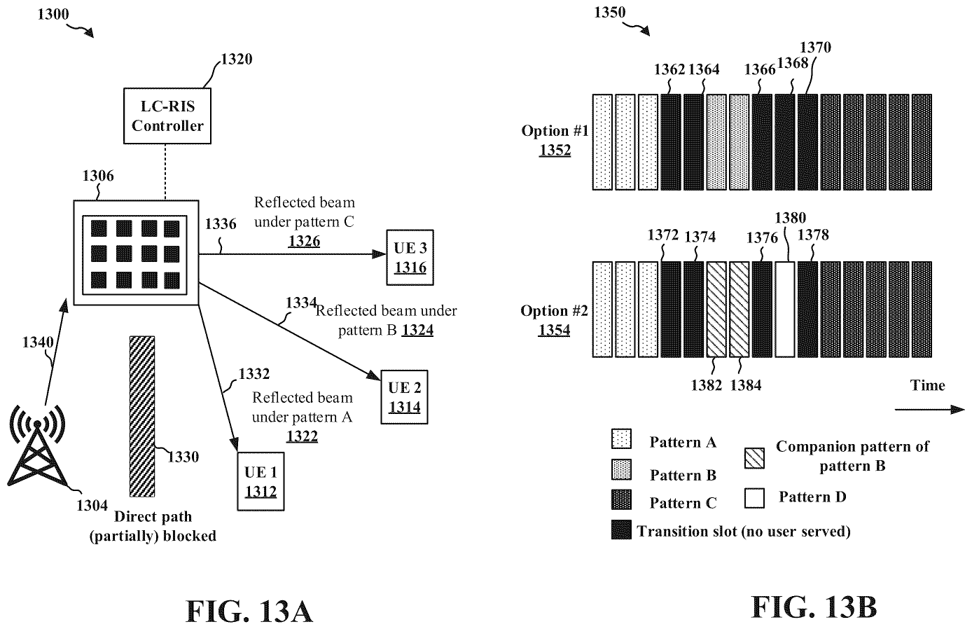

FIG. 13A is a diagram 1300 illustrating an example of configured grant operations via an RIS device in accordance with various aspects of the present disclosure. As shown in FIG. 13A, a base station 1304 may serve multiple users (e.g., UE 1 1312, UE 2 1314, and UE 3 1316) via different patterns of an RIS device 1306, e.g., to avoid a blockage 1330. For example, the base station 1304 may serve UE 1 1312 via pattern A 1322, serve UE 2 1314 via pattern B 1324, and serve UE 3 1316 via pattern C 1326. As illustrated, the RIS device 1306 may have an LC-RIS controller 1320. The RIS device 1306 may apply different RIS patterns (e.g., pattern A 1322, pattern B 1324, pattern C 1326), so that the incident wave 1340 from the base station 1304 may be respectively reflected (e.g., via 1332, 1334, 1336) towards the multiple users (e.g., UE 1 1312, UE 2 1314, and UE 3 1316). Hence, the transitions of different RIS patterns (e.g., pattern A 1322, pattern B 1324, pattern C 1326) are time-aligned with the switching of different users (e.g., UE 1 1312, UE 2 1314, and UE 3 1316). In some examples, the RIS device 1306 may be an LC-based RIS device. The order in which these users (e.g., UE 1 1312, UE 2 1314, and UE 3 1316) are served may be determined by factors such as the priority of each user and the duration of each user's resource allocation. In operations that involve LC-RIS assisted configured grants, transition times between different RIS patterns (e.g., pattern A 1322, pattern B 1324, pattern C 1326) and the selection of refinement patterns may be taken into consideration in configured grant operations to improve the efficiency of resource allocations.

In some aspects, any given set of RIS patterns (e.g., pattern A 1322, pattern B 1324, pattern C 1326) intended to be used across configured grants, both transition times and refinement patterns may be considered for the configured grant operations. FIG. 13B is a diagram 1350 illustrating an example of configured grant operations via an RIS device in accordance with various aspects of the present disclosure. As shown in FIG. 13A and FIG. 13B, three users may be served according to a fixed order. In one example (e.g., option #1 1352), the order may include user A (e.g., UE 1 1312) with pattern A 1322, followed by user B (e.g., UE 2 1314) with pattern B 1324, and then user C (e.g., UE 3 1316) with pattern C 1326. In this case, the total transition time is the sum of the individual transitions between these patterns, which include the transition time from pattern A to pattern B (which spans slots 1362 and 1364), and the transition time from pattern B to pattern C (which spans slots 1366, 1368, and 1370). In another example (option #2 1354), in an optimized setup, the transition might involve switching from user A's pattern (e.g., pattern A 1322) to a refinement pattern for user B (e.g., at 1382, 1384) that facilitates a quicker or more efficient transition to the next user's pattern. In this example, the total transition time is the sum of the transition time from pattern A to a refinement pattern of user B (which spans slots 1372 and 1374), and the transition time from the refinement pattern of user B to pattern C (which spans slots 1376 and 1378). Using a refinement pattern for one or more users with originally configured grants may significantly reduce transition times while maintaining acceptable gains, without changing the order and resource allocation durations of those users. For example, the reduced transition time between the refinement pattern of user B to pattern C allows an additional user to be served at slot 1380.

To implement this approach, the network node (e.g., base station 1304) may access information provided by OAM or directly query the RIS controller 1320 to obtain suitable refinement patterns along with their associated transition times and possibly an optimized order. In some examples, when querying the RIS controller 1320 to obtain suitable refinement patterns, the network node (e.g., base station 1304) may indicate an initial choice of intended patterns and the acceptable margins and durations for resource allocation, so that proper refinement patterns may be obtained.

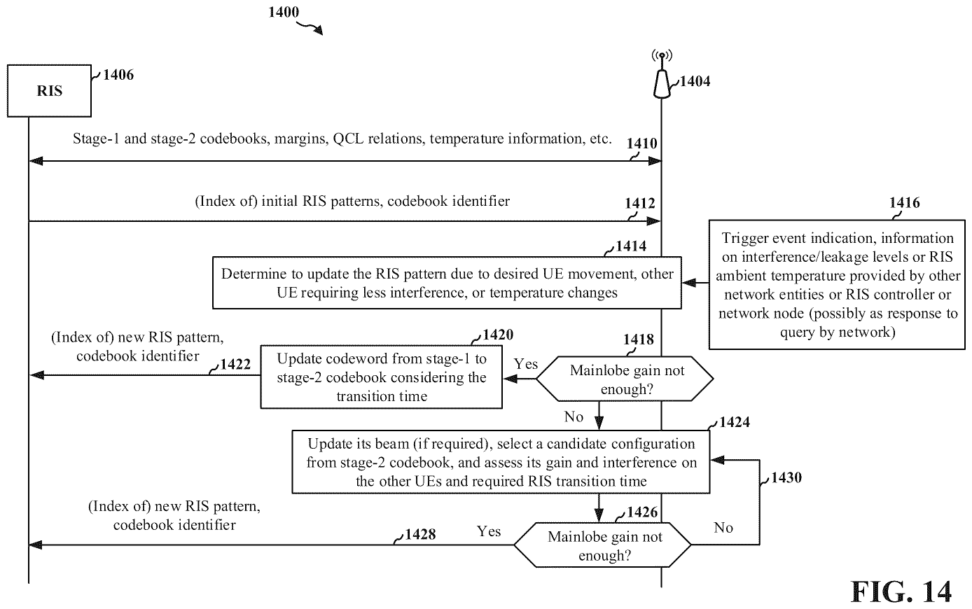

FIG. 14 is a call flow diagram illustrating the selection of codeword (or companion codeword) for an RIS device 1406 in accordance with various aspects of the present disclosure. Various aspects are described in connection with a base station 1404 and the RIS device 1406. In some examples, the RIS device 1406 may be an LC-based RIS device. The aspects may be performed by the RIS device 1406 in collaboration with the base station 1404 in aggregation and/or by one or more components of the base station 1404 (e.g., a CU 110, a DU 130, and/or an RU 140). For example, the base station 1404 may be base station 1104, 1204, 1304, and the RIS device 1406 may be RIS device 1106, 1206, 1306.

As shown in FIG. 14, at 1410, the base station 1404 and the RIS device 1406 may exchange information that facilitates the selection of a proper codebook (or pattern) for the RIS device 1406. This information may include, for example, state-1 codebooks, stage-2 codebooks associated with the stage-1 codebooks, margin information (e.g., acceptable gain margins), spatial relations (e.g., spatial QCL relations among the stage-1 and stage-2 codewords), and temperature information. In some examples, the base station 1404 and the RIS device 1406 may also exchange transition time information at 1410. For example, referring to FIG. 11, the base station 1104 and the RIS device 1106 may exchange information such as two-stage codebook information (e.g., stage-1 codeword 1030 and the associated stage-2 codebook 1040) and LC-RIS transition time table (e.g., PAT table 740).

At 1412, the RIS device 1406 may indicate the initial (or current) RIS pattern and codebook to the base station 1404. For example, the RIS device 1406 may provide the index of the initial (or current) RIS pattern or a codework identifier to the base station 1404.

At 1414, the base station 1404 may determine whether to update the RIS pattern (or codeword). The decision may depend on various factors, such as UE movement (e.g., which may result in a mismatch, such as reduced directivity, between the initial pattern and the UE), changes in interference conditions (e.g., reducing interference for other UE), or changes in environmental conditions (e.g., temperature changes).

In some examples, at 1418, the base station 1404 may determine to update the RIS pattern (or codeword) based on a trigger event indication, information on interference/leakage levels, or RIS ambient temperature provided by other network entities, an RIS controller, or a network node. In some examples, this information may be obtained in response to a query from the base station 1404.

In some examples, if the base station 1404 decides to update the RIS pattern (or codeword), the base station may first determine, at 1418, whether the gain of the main lobe (e.g., the beam 1108, 1208) is sufficiently large (e.g., exceed a defined gain threshold). If the gain is sufficient, the base station 1404 may, at 1420, update the pattern (or codeword) from stage-1 codebook to the corresponding stage-2 codebook considering the transition time. For example, referring to FIG. 11, the base station 1104 may update the pattern (or codeword) from stage-1 codebook (e.g., pattern A 1122) to the corresponding stage-2 codebook (e.g., refinement pattern 1124 of pattern A 1122) considering the transition time. Then, the base station 1404 may, at 1422, indicate (or activate) the new pattern (or codeword) to the RIS device 1406, such as by indicating the index of the new RIS pattern or the identifier of the new codeword or codebook to the RIS device 1406.

On the other hand, if the gain of the main lobe (e.g., the beam 1108, 1208) is insufficient (e.g., below the defined gain threshold), the base station 1404 may, at 1424, update its beam (if necessary). The base station 1404 then may select a candidate configuration from the stage-2 codebook and assess whether it satisfies various conditions for use. These conditions may include, for example, the candidate's gain, its impact on interference on the other UEs, and whether it meets the required RIS transition time.

At 1426, the base station 1404 may evaluate whether the gain of the main lobe based on the selected candidate configuration is sufficient (e.g., exceeds the defined gain threshold). If the gain is sufficient, the base station 1404 may, at 1428, indicate (or activate) the new pattern (or codeword) based on the selected candidate configuration to the RIS device 1406. For example, the base station 1404 may indicate the index of the new RIS pattern or the identifier of the new codeword or codebook to the RIS device 1406.

On the other hand, if the gain of the main lobe based on the selected candidate configuration is insufficient (e.g., below the defined gain threshold), the base station 1404 may, at 1430, return to step 1424 to select another candidate configuration. This process is repeated until a configuration is identified that satisfies the gain condition for the main lobe (e.g., the gain exceeds the defined gain threshold).

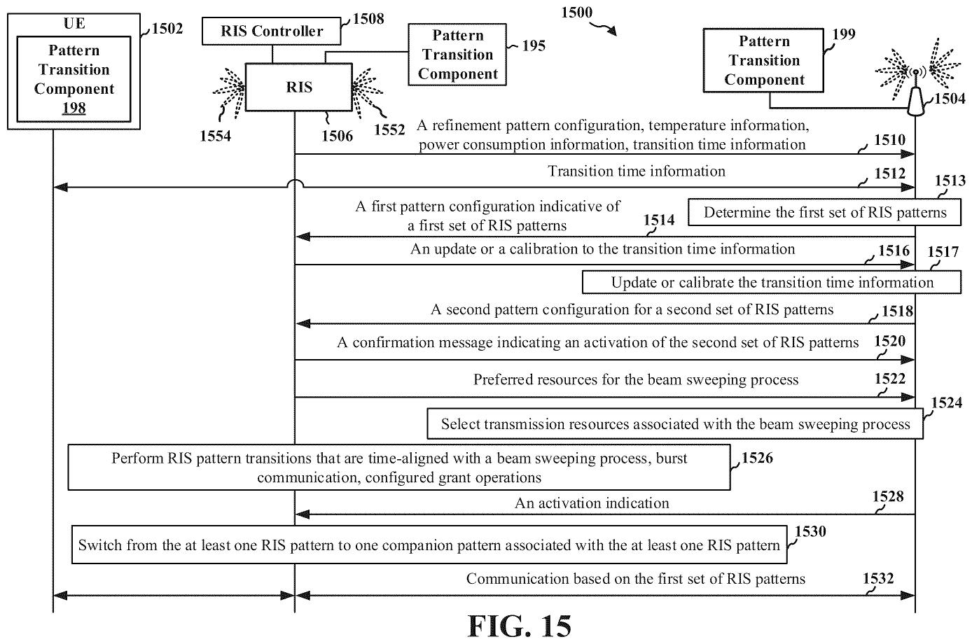

FIG. 15 is a call flow diagram 1500 illustrating a method of wireless communication in accordance with various aspects of this present disclosure. Various aspects are described in connection with a UE 1502, a base station 1504, and an RIS device 1506. As illustrated, the RIS device 1506 may have (or be associated with) an RIS controller 1508, which may control the pattern (or codeword) of the RIS device 1506. Various aspects in the call flow diagram 1500 may be respectively performed by the UE 1502 (or, more specifically, the pattern transition configuration component 198 in the UE 1502), the base station 1504 in aggregation and/or by one or more components of a base station 1504 (e.g., a CU 110, a DU 130, and/or an RU 140), or the RIS device 1506 (or, more specifically, the pattern transition component 195 in the RIS device 1506). For example, the RIS device 1506 may be RIS device 806, 906, 1006, 1106, 1206, 1306, 1406. The base station 1504 may be base station 804, 904, 1004, 1104, 1204, 1304, 1404. The UE 1502 may be UE 1 912, UE 2 914, UE 3 916, UE 1112, UE 1 1212, UE 1 1312, UE 2 1314, and UE 3 1316.

As shown in FIG. 15, at 1510, the base station 1504 may receive from the RIS device 1506 various information related to the operation of the RIS device 1506. For example, the information may include a refinement pattern configuration, temperature information, power consumption information, and transition time information. For example, the refinement pattern configuration may include information of stage-1 codebooks and stage-2 codebooks for the RIS device 1506, such as the association between the stage-1 codebooks and their corresponding stage-2 codebooks. Each codebook may include one or more codewords (or RIS patterns), and each codeword (or) may correspond to a combination of an incident beam 1552 along an incident direction (e.g., θᵢ, Øᵢ in Equation (1)) and a reflected beam 1554 along a reflected direction (e.g., θ_{d}, Ø_{d} in Equation (2)). For downlink transmission from the base station 1504 to UE 1502, the incident beam 1552 has a beam direction from the base station 1504 to the RIS device 1506, and the reflected beam 1554 has a beam direction from the RIS device 1506 to UE 1502. For uplink transmission from the UE 1502 to base station 1504, the incident beam has a beam direction from the UE 1502 to the RIS device 1506, and the reflected beam has a beam direction from the RIS device 1506 to base station 1504. For example, the power consumption information may relate to the power consumption for multiple operational modes for transitioning RIS patterns in RIS device 1506. For example, these operational modes may include, for example, a regular mode and a fast mode, where the fast mode may enable quicker transition times compared to the regular mode but at the cost of higher power consumption.

In some examples, the transition time information may include the transition time the RIS device 1506 needs to transition between two RIS patterns (e.g., from a first RIS pattern to a second RIS pattern). For example, the transition time may be based on two RIS patterns involved in the transition (e.g., the first RIS pattern and the second RIS pattern) and the direction of the transition (e.g., from the first RIS pattern to the second RIS pattern, or from the second RIS pattern to the first RIS pattern). In some examples, the transition time information may include a pattern transition time table, such as PAT table 740, with entries of specifying transition times for different RIS pattern pairs. In some examples, the transition times in the pattern transition time table (e.g., PAT table 740) may be specified in the unit of time, slots, or symbols. In some examples, when the transition times are specified in the unit of slots or symbols, the transition times may be further based on the SCS. In some examples, the transition time information may include an intra-group transition time and inter-group transition information. The intra-group transition time may correspond to an intra-group transition between the RIS patterns within one pattern group of the one or more pattern groups of RIS patterns, and the inter-group transition information corresponds to an inter-group transition between the RIS patterns on different pattern groups of the one or more pattern groups. The inter-group transition information may include a common inter-group transition time for the inter-group transitions between the RIS patterns on the different pattern groups of the one or more pattern groups.

In some examples, the inter-group transition information may include a set of inter-group transition times respectively corresponding to the inter-group transitions between any two RIS patterns on the different pattern groups of the one or more pattern groups. In some examples, the transition time information may include a common transition time and a corresponding transition offset for each of the two or more transitions, and the transition time between the two RIS patterns is represented by a combination of the common transition time and the corresponding transition offset.

At 1512, the UE 1502 may exchange the transition time information with the base station 1504.

At 1513, the base station 1504 may determine the first set of RIS patterns based on the transition time information (e.g., received at 1512) for the two or more transitions between the two or more RIS pattern. For example, the base station 1504 may determine the first set of RIS patterns, including the RIS patterns in the first set of RIS patterns and the order of these RIS patterns, to minimize the total transition time to traverse these RIS patterns.

At 1514, the UE 1502 may transmit a first pattern configuration to the RIS device 1506. The first pattern configuration may indicate a first set of RIS patterns. The first set of patterns may include two or more RIS patterns, which may be adapted based on transition time information for two or more transitions between the two or more RIS patterns (e.g., at 1510). In some examples, the transition time information for each transition of the two or more transitions may be based on the change between a first RIS pattern and a second RIS pattern in the tow or more RIS pattern and the direction of the change (e.g., change from the first RIS pattern to the second RIS pattern or vice versa). In some examples, the first pattern configuration may indicate the order of the RIS patterns among the first set of RIS patterns. The order may be determined based on the transition time information. For example, the order of the RIS patterns may be selected to minimize the total time needs for the RIS device to traverse all the RIS patterns within the first set of RIS patterns. In some examples, the base station 1504 may communicate with the UE 1502 based on the first set of RIS patterns (e.g., at 1532).

At 1516, the RIS device 1506 may report (e.g., to base station 1504) an update or a calibration to the transition time information (e.g., the PAT table 740) in response to a deviation of the transition times.

At 1517, the base station 1504 may update or a calibrate the transition time information (e.g., the PAT table 740) in response to a deviation of the transition times.

At 1518, the base station 1504 may transmit a second pattern configuration to the RIS device 1506, specifying a second set of RIS patterns. For example, the base station 1504 may transmit the second pattern configuration when communication with UE 1502 using the first set of RIS patterns no longer provides sufficient quality (e.g., due to changes in interference conditions or environmental factors, such as temperature fluctuations). For example, the second set of RIS patterns may be selected based on the process described in the call flow diagram 1400.

At 1520, the RIS device 1506 may send a confirmation message to the base station 1504, indicating an application (or activation) of the second set of RIS patterns. For example, this confirmation message may be sent if the adjustment time to transition to the second set of RIS patterns is less than a threshold adjustment time.

In some aspects, the base station 1504, the RIS device 1506, and UE 1502 may perform a beam sweeping process. The beam sweeping process may be time-aligned with the RIS pattern transitions on the RIS device 1506. At 1522, the RIS device 1506 may indicate preferred resources for the beam sweeping process to the base station 1504.

In some aspects, at 1524, the base station 1504 may select transmission resources associated with the beam sweeping process. In some examples, the selection of the transmission resource may be based on the preferred resources indicated by the RIS device 1506 at 1522.

At 1526, the base station 1504, the RIS device 1506 may perform RIS pattern transitions that are time-aligned with the beam sweeping process, burst communication or configurated grant operations between the base station 1504 and UE 1502. For example, referring to FIG. 8, during the beam sweeping process, the RIS device 806 may use different codewords (or RIS patterns), such as pattern A 822, pattern B 824, pattern C 826, to generate various reflected beams. The timing of applying different RIS patterns on the RIS device 1506 may coincide with the timing of the beam switching in the beam sweeping process. The sweeping order (e.g., the order of using the different codewords or RIS patterns) may be based on the transition time information corresponding to these RIS patterns. In some examples, by choosing a proper sweeping order based on the transition time information, the total time for the beam sweeping process may be reduced.

In addition to the beam sweeping process, the base station 1504, the RIS device 1506, and UE 1502 may perform other operations, such as burst communication with multiple users or configured grant operations. For example, referring to FIG. 9A, the base station 904 may conduct burst communication with multiple users, such as UE 1 912, UE 2 914, and UE 3 916, via the RIS device 906. The RIS device 906 may use different codewords (or RIS patterns), such as pattern A 922, pattern B 924, pattern C 926, to direct reflected beams to different users. The timing of applying different RIS patterns on the RIS device 906 may coincide with the timing of the switching of users. In some examples, the order of applying these RIS patterns (e.g., pattern A 922, pattern B 924, pattern C 926) may be based on the transition time information corresponding to these RIS patterns.

In some examples, at 1526, the base station 1504 may perform configured grant operations via the RIS device 1506. Referring to FIG. 13A, the base station 1304 may serve multiple users (e.g., UE 1 1312, UE 2 1314, and UE 3 1316) via different patterns of the RIS device 1306, such as pattern A 1322, pattern B 1324, and pattern C 1326. The timing of applying different RIS patterns on the RIS device 1306 may coincide with the timing of the switching of users. The order in which these users (e.g., UE 1 1312, UE 2 1314, and UE 3 1316) are served may be based on factors such as the priority of each user and the duration of each user's resource allocation, transition times between different RIS patterns (e.g., pattern A 1322, pattern B 1324, pattern C 1326), and available refinement patterns. For example, using refinement patterns (e.g., at 1382, 1384) may facilitate quicker transitions to reduce the total transition time for serving these users.

At 1528, the base station 1504 may send an activation indication to the RIS device 1506 to indicate the RIS device 1506 to activate one refinement pattern associated with the at least one RIS pattern when a trigger condition is met. For example, the trigger condition may include the occurrence of a mismatch in the current RIS pattern. For example, in FIG. 11, the mismatch may occur when the beam associated with pattern A 1122 drifts from 1132 to 1132′ (e.g., due to temperature changes), misaligning with UE 1112.

At 1530, the RIS device 1506 may switch from the at least one RIS pattern to one refinement pattern associated with the at least one RIS pattern. That is, the RIS device 1506 may activate the refinement pattern. For example, in FIG. 11, the RIS device 1106 may switch from pattern A 1122 (corresponding to beam 1132′) to refinement pattern 1124 (corresponding to beam 1134) of pattern A 1122 (i.e., activate refinement pattern 1124) to achieve better directivity towards UE 1112.

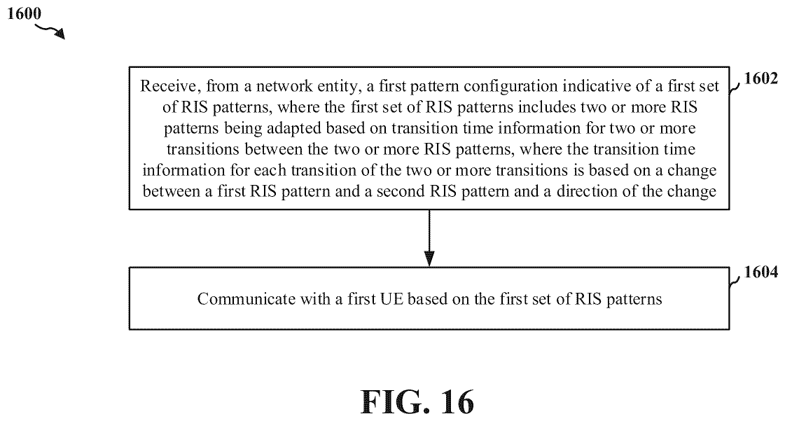

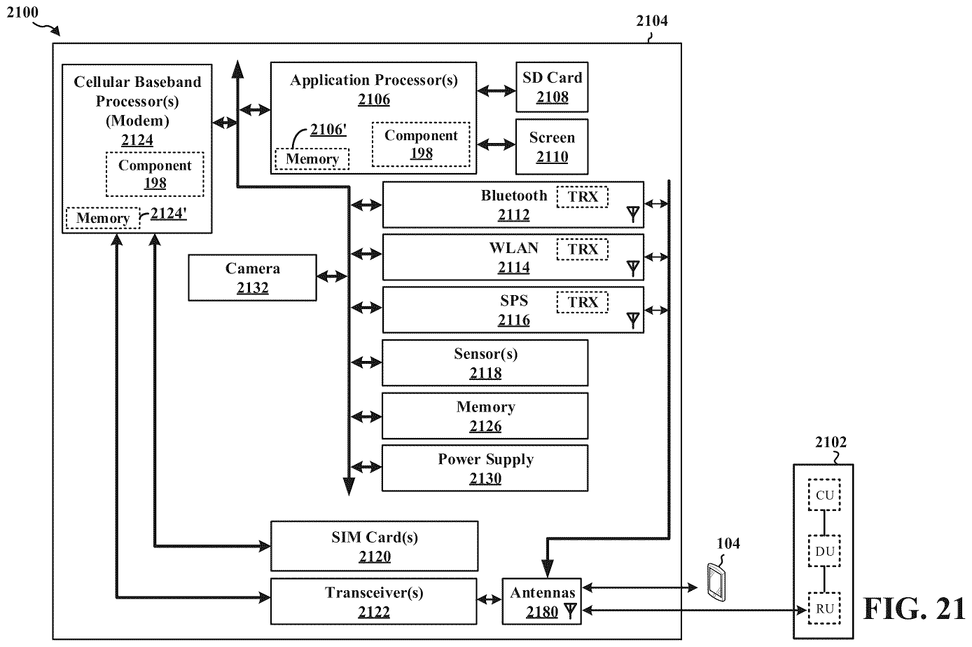

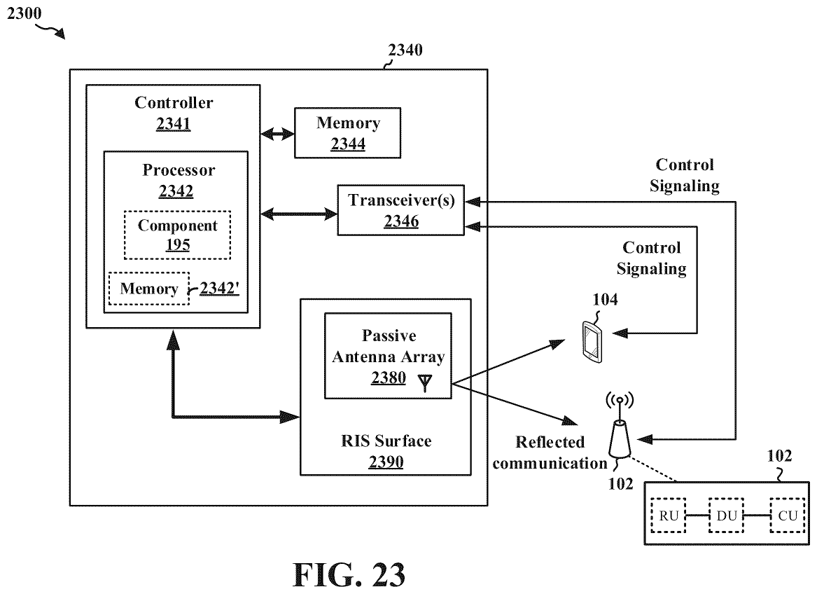

FIG. 16 is a flowchart 1600 illustrating methods of wireless communication at an RIS device in accordance with various aspects of the present disclosure. The method may be performed by an RIS device in collaboration with a UE (e.g., the first UE) and a network entity. The RIS device may be RIS device 806, 906, 1006, 1106, 1206, 1306, 1406, 1506; or RIS 2340 in the hardware implementation of FIG. 23. The network entity may be a base station, or a component of a base station, in the access network of FIG. 1 or a core network component (e.g., base station 102, 310, 804, 904, 1004, 1104, 1204, 1304, 1404, 1504; or the network entity 2102 in the hardware implementation of FIG. 21). The UE may be the UE 104, 350, 1112, 1212, 1502, UE 1 912, 1312, UE 2 914, 1314, UE 3 916, 1316, or the apparatus 2104 in the hardware implementation of FIG. 21. By utilizing transition time information for the transitions between the RIS patterns to optimize the beam orders in various operations, including beam sweeping and/or burst communication, the methods reduce the time to adjust the RIS configuration across multiple patterns, thereby improving the overall responsiveness of the network to changes in network condition and environment. Additionally, by configuring companion (or second-stage) codebooks with associated pattern transition times, margins, and ambient temperature information, the methods can be used to adjust the RIS configurations based on environmental changes such as temperature fluctuations, thereby maintaining optimal signal quality and reducing the risk of service degradation or interruption due to environmental factors. In some examples, by enabling dynamic adjustment of RIS configurations in response to updated interference requirements and ambient conditions, the methods maintain optimal signal reflection and directionality, thereby ensuring efficient use of the RIS device under varying network load and interference conditions.

As shown in FIG. 16, at 1602, the RIS device may receive, from a network entity, a first pattern configuration indicative of a first set of RIS patterns. The first set of RIS patterns may include two or more RIS patterns. The two or more RIS patterns may be adapted based on transition time information for two or more transitions between the two or more RIS patterns. The transition time information for each transition of the two or more transitions may be based on the change between a first RIS pattern and a second RIS pattern and a direction of the change. FIG. 8, FIG. 9A, FIG. 9B, FIG. 10, FIG. 11, FIG. 12, FIG. 13A, FIG. 13B, FIG. 14, and FIG. 15 illustrate various aspects of the steps in connection with flowchart 1600. For example, referring to FIG. 8 and FIG. 15, the RIS device 1506 may, at 1514, receive from a network entity (e.g., base station 1504) a first pattern configuration indicative of a first set of RIS patterns (e.g., pattern A 822, pattern B 824, pattern C 826). The first set of RIS patterns (e.g., pattern A 822, pattern B 824, pattern C 826) may be adapted based on transition time information for two or more transitions between two or more RIS patterns (e.g., pattern A 822, pattern B 824, pattern C 826). The transition time information for each transition of the two or more transitions may be based on the change of the RIS pattern between a first RIS pattern (e.g., pattern A 822) and a second RIS pattern (e.g., pattern B 824) and the direction of the change. In some aspects, 1602 may be performed by the pattern transition component 195.

At 1604, the RIS device may communicate with a first UE based on the first set of RIS patterns. The communication between the RIS device and the first UE may include reflecting communication between the base station and the first UE. For example, referring to FIG. 15, the RIS device 1506 may, at 1532, communicate with the first UE (e.g., UE 1502) based on the first set of RIS patterns. Referring to FIG. 9A, the communication between the RIS device 906 and the first UE (e.g., UE 1 912) may include reflecting communication between the base station 904 and the first UE (e.g., UE 1 912). In some aspects, 1604 may be performed by the pattern transition component 195.

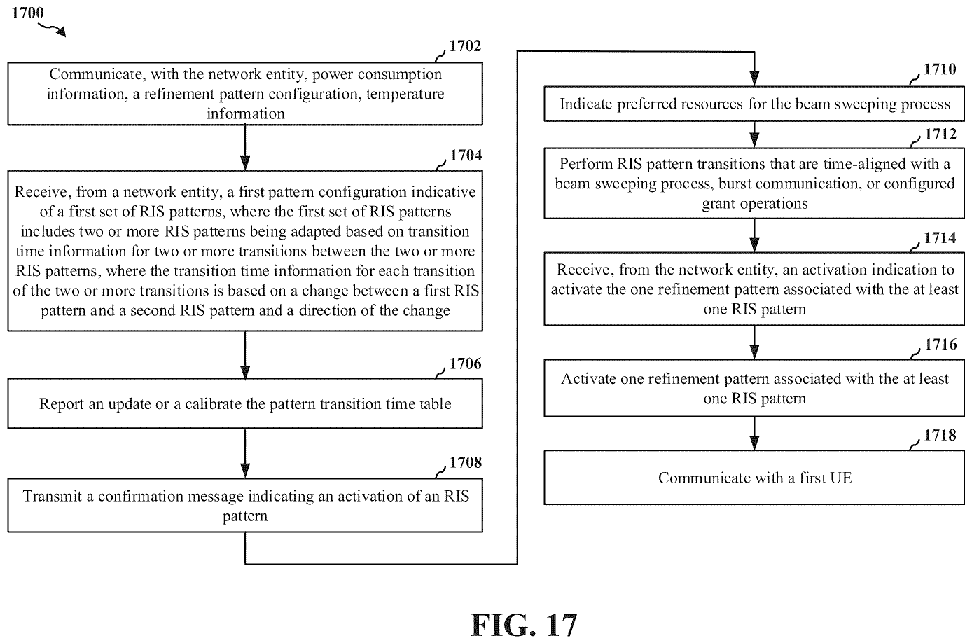

FIG. 17 is a flowchart 1700 illustrating methods of wireless communication at an RIS device in accordance with various aspects of the present disclosure. The method may be performed by an RIS device in collaboration with a UE (e.g., the first UE) and a network entity. The RIS device may be RIS device 806, 906, 1006, 1106, 1206, 1306, 1406, 1506; or RIS 2340 in the hardware implementation of FIG. 23. The network entity may be a base station, or a component of a base station, in the access network of FIG. 1 or a core network component (e.g., base station 102, 310, 804, 904, 1004, 1104, 1204, 1304, 1404, 1504; or the network entity 2102 in the hardware implementation of FIG. 21). The UE may be the UE 104, 350, 1112, 1212, 1502, UE 1 912, 1312, UE 2 914, 1314, UE 3 916, 1316, or the apparatus 2104 in the hardware implementation of FIG. 21. By utilizing transition time information for the transitions between the RIS patterns to optimize the beam orders in various operations, including beam sweeping and/or burst communication, the methods reduce the time to adjust the RIS configuration across multiple patterns, thereby improving the overall responsiveness of the network to changes in network condition and environment. Additionally, by configuring companion (or second-stage) codebooks with associated pattern transition times, margins, and ambient temperature information, the methods can be used to adjust the RIS configurations based on environmental changes such as temperature fluctuations, thereby maintaining optimal signal quality and reducing the risk of service degradation or interruption due to environmental factors. In some examples, by enabling dynamic adjustment of RIS configurations in response to updated interference requirements and ambient conditions, the methods maintain optimal signal reflection and directionality, thereby ensuring efficient use of the RIS device under varying network load and interference conditions.

As shown in FIG. 17, at 1704, the RIS device may receive, from a network entity, a first pattern configuration indicative of a first set of RIS patterns. The first set of RIS patterns may include two or more RIS patterns being adapted based on transition time information for two or more transitions between the two or more RIS patterns. The transition time information for each transition of the two or more transitions may be based on the change between a first RIS pattern and a second RIS pattern and a direction of the change. FIG. 8, FIG. 9A, FIG. 9B, FIG. 10, FIG. 11, FIG. 12, FIG. 13A, FIG. 13B, FIG. 14, and FIG. 15 illustrate various aspects of the steps in connection with flowchart 1700. For example, referring to FIG. 8 and FIG. 15, the RIS device 1506 may, at 1514, receive from a network entity (e.g., base station 1504) a first pattern configuration indicative of a first set of RIS patterns (e.g., pattern A 822, pattern B 824, pattern C 826). The first set of RIS patterns (e.g., pattern A 822, pattern B 824, pattern C 826) may be adapted based on transition time information for two or more transitions between two or more RIS patterns (e.g., pattern A 822, pattern B 824, pattern C 826). The transition time information for each transition of the two or more transitions may be based on the change of the RIS pattern between a first RIS pattern (e.g., pattern A 822) and a second RIS pattern (e.g., pattern B 824) and the direction of the change. In some aspects, 1704 may be performed by the pattern transition component 195.

At 1718, the RIS device may communicate with a first UE, for example, based on the first set of RIS patterns. The communication between the RIS device and the first UE may include reflecting communication between the base station and the first UE. For example, referring to FIG. 15, the RIS device 1506 may, at 1532, communicate with the first UE (e.g., UE 1502) based on the first set of RIS patterns. Referring to FIG. 9A, the communication between the RIS device 906 and the first UE (e.g., UE 1 912) may include reflecting communication between the base station 904 and the first UE (e.g., UE 1 912). In some aspects, 1718 may be performed by the pattern transition component 195.

In some aspects, the transition time information may include a pattern transition time table, and the entries of the pattern transition time table may include transition times between two or more RIS patterns, and the first pattern configuration may include the first set of RIS patterns according to an order, and the order is based on the transition time information. For example, referring to FIG. 7, the transition time information may include a PAT table 740, and the entries of the PAT table 740 may include transition times between two or more RIS patterns (e.g., 722 and 724). The first pattern configuration may include the first set of RIS patterns according to an order (e.g., the order of from pattern B 824 to pattern A 822 and then to pattern C 826), and the order (e.g., the order of from pattern B 824 to pattern A 822 and then to pattern C 826) may be based on the transition time information.

In some aspects, the transition time table may include a first entry and a second entry corresponding to the transition between the first RIS pattern and the second RIS pattern, and the first entry may correspond to a first transition time from the first RIS pattern to the second RIS pattern, and the second entry corresponds to a second transition time from the second RIS pattern to the first RIS pattern. For example, referring to FIG. 7, the PAT table 740 may include a first entry 702 and a second entry 704 corresponding to the transition between the first RIS pattern (e.g., 722) and the second RIS pattern (e.g., 724), and the first entry 702 may correspond to a first transition time from the first RIS pattern (e.g., 722) to the second RIS pattern (e.g., 724), and the second entry 704 corresponds to a second transition time from the second RIS pattern (e.g., 724) to the first RIS pattern (e.g., 722).

In some aspects, the transition times in the pattern transition time table may be specified in the unit of time, slots, or symbols. When the transition times are specified in the unit of slots or symbols, the transition times may be further based on the SCS. For example, referring to FIG. 7, the transition times in the PAT table 740 may be specified in the unit of time, slots, or symbols. When the transition times in the PAT table 740 are specified in the unit of slots or symbols, the transition times in the PAT table 740 may be further based on the SCS.

In some aspects, the first set of RIS patterns may include two or more pattern groups of RIS patterns, and the transition time information may include an intra-group transition time and inter-group transition information. The intra-group transition time may correspond to intra-group transitions between any two RIS patterns of the RIS patterns within one pattern group of the two or more pattern groups of RIS patterns, and the inter-group transition information may correspond to inter-group transitions between any two RIS patterns on different pattern groups of the two or more pattern groups. For example, referring to FIG. 15, the transition time information (e.g., at 1510, 1512) may include an intra-group transition time and inter-group transition information. The intra-group transition time may correspond to intra-group transitions between any two RIS patterns within one pattern group of the two or more pattern groups of RIS patterns, and the inter-group transition information may correspond to inter-group transitions between any two RIS patterns on different pattern groups of the two or more pattern groups.

In some aspects, the inter-group transition information may include a common inter-group transition time for the inter-group transitions between any two RIS patterns on the different pattern groups of the two or more pattern groups. For example, referring to FIG. 15, the inter-group transition information (e.g., included in the transition time information at 1510, 1512) may include a common inter-group transition time for the inter-group transitions between any two RIS patterns on the different pattern groups of the two or more pattern groups.

In some aspects, the inter-group transition information may include one or more inter-group transition times respectively corresponding to the inter-group transitions between the RIS patterns on the different pattern groups of the two or more pattern groups. For example, referring to FIG. 15, the inter-group transition information (e.g., included in the transition time information at 1510, 1512) may include one or more inter-group transition times respectively corresponding to the inter-group transitions between the RIS patterns on the different pattern groups of the two or more pattern groups.

In some aspects, the transition time information may include a common transition time and a corresponding transition offset for each of the two or more transitions, and the transition time between the two RIS patterns may be represented by a combination of the common transition time and the corresponding transition offset. For example, referring to FIG. 15, the transition time information (e.g., at 1510, 1512) may include a common transition time and a corresponding transition offset for each of the two or more transitions, and the transition time between the two RIS patterns (e.g., pattern A 822, pattern B 824) may be represented by a combination of the common transition time and the corresponding transition offset.

In some aspects, the transition time information may include a first traverse time and a second traverse time. The first traverse time may correspond to a first traverse of one or more RIS patterns in the first set of RIS patterns based on a first order, and the second traverse time may correspond to a second traverse of the one or more RIS patterns in the first set of RIS patterns based on a reverse of the first order. For example, referring to FIG. 15, the transition time information (e.g., at 1510, 1512) may include a first traverse time and a second traverse time. The first traverse time may correspond to a first traverse of one or more RIS patterns in the first set of RIS patterns based on a first order, and the second traverse time may correspond to a second traverse of the one or more RIS patterns in the first set of RIS patterns based on a reverse of the first order.

In some aspects, at 1706, the RIS device may report an update or a calibrate on the pattern transition time table in response to a deviation of the transition times. For example, referring to FIG. 15, the RIS device 1506, may, at 1516, report an update or a calibration to the pattern transition time table in response to a deviation of the transition times. For example, referring to FIG. 11, this update or calibration process may be triggered by changes in environmental conditions (e.g., the ambient temperature), which may cause a deviation or change on the transition times. In some aspects, 1706 may be performed by the pattern transition component 195.

In some aspects, the RIS device may, at 1708, transmit to the network entity a confirmation message indicating an activation of an RIS pattern in response to a time for transition to the RIS pattern being less than a threshold time. For example, referring to FIG. 15, the RIS device 1506 may, at 1518, receive from the network entity (e.g., base station 1504) a second pattern configuration for a second set of RIS patterns and, at 1520, transmit to the network entity (e.g., base station 1504) a confirmation message indicating an activation of an RIS pattern (e.g., an RIS pattern in the second set of RIS patterns) in response to a time for transition to the RIS pattern being less than a threshold time. In some aspects, 1708 may be performed by the pattern transition component 195.

In some aspects, at 1702, the RIS device may transmit, to the network entity, power consumption information corresponding to multiple operational modes for the two or more transitions. The multiple operational modes may include a regular mode and a fast mode. A regular transition time under the regular mode is longer than a fast transition time under the fast mode for the two or more transitions, and the first pattern configuration is based on the power consumption information. For example, referring to FIG. 15, the RIS device 1506 may, at 1510, transmit to the network entity (e.g., base station 1504) power consumption information corresponding to multiple operational modes for the two or more transitions of the RIS device 1506. In some aspects, 1702 may be performed by the pattern transition component 195.

In some aspects, at 1712, the RIS device may perform RIS pattern transitions that are time-aligned with a beam sweeping process using one or more RIS patterns in the first set of RIS patterns according to a sweeping order of the one or more RIS patterns. The sweeping order is based on the transition time information corresponding to the one or more RIS patterns. For example, referring to FIG. 8 and FIG. 15, the RIS device 1506 may, at 1526, perform RIS pattern transitions that are time-aligned with a beam sweeping process using one or more RIS patterns (e.g., pattern A 822, pattern B 824, pattern C 826) in the set of RIS patterns according to a sweeping order of the one or more RIS patterns. The sweeping order is based on the transition time information corresponding to the one or more RIS patterns (e.g., pattern A 822, pattern B 824, pattern C 826). In some aspects, 1712 may be performed by the pattern transition component 195.

In some aspects, the total transition time based on the sweeping order of the one or more RIS patterns is shorter than or equal to an alternative transition time based on an alternative order of the one or more RIS patterns different from the sweeping order. For example, referring to FIG. 8, by considering the transition time information between pattern A 822, pattern B 824, pattern C 826 and arranging the order of these patterns accordingly, the total transition time may be reduced (e.g., shorter than an order that does not consider the transition time information).

In some aspects, the transmission resources associated with the beam sweeping process using the one or more RIS patterns in the first set of RIS patterns may be based on the transition time information corresponding to the one or more RIS patterns. For example, referring to FIG. 8, the transmission resources associated with the beam sweeping process using the one or more RIS patterns (e.g., pattern A 822, pattern B 824, pattern C 826) in the first set of RIS patterns may be based on the transition time information corresponding to the one or more RIS patterns (e.g., pattern A 822, pattern B 824, pattern C 826).

In some aspects, at 1710, the RIS device may indicate, to the network entity, preferred resources for the beam sweeping process. The transmission resources associated with the beam sweeping process may be based on the preferred resources. For example, referring to FIG. 15, the RIS device 1506 may, at 1522, indicate to the network entity (e.g., base station 1504) preferred resources for the beam sweeping process. The transmission resources associated with the beam sweeping process (e.g., at 1526) may be based on the preferred resources. In some aspects, 1710 may be performed by the pattern transition component 195.

In some aspects, at 1712, the RIS device may perform RIS pattern transition that are time-aligned with burst communication with multiple UEs including the first UE respectively using one or more RIS patterns in the first set of RIS patterns according to a communication order of the one or more RIS patterns. The communication order may be based on the transition time information corresponding to the one or more RIS patterns. For example, referring to FIG. 9A and FIG. 15, the RIS device 1506 may, at 1526, perform RIS pattern transitions that are time-aligned with burst communication with multiple UEs (e.g., UE 1 912, UE 2 914, UE 3 916) including the first UE respectively using one or more RIS patterns (e.g., pattern A 922, pattern B 924, pattern C 926) in the first set of RIS patterns according to a communication order of the one or more RIS patterns. The communication order may be based on the transition time information corresponding to the one or more RIS patterns (e.g., pattern A 922, pattern B 924, pattern C 926).

In some aspects, the total communication time of the burst communication based on the communication order of the one or more RIS patterns may be shorter than or equal to an alternative total communication time based on an alternative order of the one or more RIS patterns different from the communication order. For example, referring to FIG. 9A, by considering the transition time information between pattern A 922, pattern B 924, pattern C 926 and arranging the order of these patterns accordingly, the total communication time for burst communication may be reduced (e.g., shorter than an order that does not consider the transition time information).

In some aspects, at least one RIS pattern in the first set of RIS patterns may be associated with one or more refinement patterns, and the association of the at least one RIS pattern with the one or more refinement patterns may be based on the transition time information for the transitions among the at least one RIS pattern and the one or more refinement patterns. For example, referring to FIG. 10, at least one RIS pattern (e.g., stage-1 codeword 1030) in the first set of RIS patterns may be associated with one or more refinement patterns (e.g., stage-2 codewords 1042, 1044, 1046), and the association of the at least one RIS pattern (e.g., stage-1 codeword 1030) with the one or more refinement patterns (e.g., stage-2 codewords 1042, 1044, 1046) may be based on the transition time information for the transitions among the at least one RIS pattern (e.g., stage-1 codeword 1030) and the one or more refinement patterns (e.g., stage-2 codewords 1042, 1044, 1046).

In some aspects, the one or more refinement patterns may be associated with the at least one RIS pattern via a spatial relation, and the one or more refinement patterns may respectively correspond to multiple gain margins within a margin range. For example, referring to FIG. 10, the one or more refinement patterns (e.g., stage-2 codewords 1042, 1044, 1046) may be associated with the at least one RIS pattern (e.g., stage-1 codeword 1030) via a QCL relation (e.g., a spatial QCL relation), and the one or more refinement patterns (e.g., stage-2 codewords 1042, 1044, 1046) may respectively correspond to multiple gain margins within a margin range (e.g., the stage-2 codewords 1042, 1044, 1046 may respectively correspond to multiple gain margins within a margin range of the gain margin of stage-1 codeword 1030).

In some aspects, at 1702, the RIS device may communicate, with the network entity, a refinement pattern configuration indicative of the one or more refinement patterns associated with the at least one RIS pattern in the first set of RIS patterns. For example, referring to FIG. 15, the RIS device 1506 may, at 1510, communicate with the network entity (e.g., base station 1504) a refinement pattern configuration indicative of the one or more refinement patterns associated with the at least one RIS pattern in the first set of RIS patterns.

In some aspects, at 1716, the RIS device may activate one refinement pattern associated with the at least one RIS pattern based on a ambient temperature, and communicate with the first UE (e.g., at 1718) based on the one refinement pattern. For example, referring to FIG. 11, the RIS device 1106 may switch the at least one RIS pattern (e.g., pattern A 1122) to one refinement pattern associated with the at least one RIS pattern (e.g., a refinement pattern 1124 of pattern A 1122) based on a pattern of temperature change among one or more ambient temperatures with respect to a time, and the one refinement pattern (e.g., a refinement pattern 1124 of pattern A 1122) may correspond to one ambient temperature of the one or more ambient temperatures corresponding to a current time. The RIS device 1106 may communicate with the first UE (e.g., UE 1112) based on the one refinement pattern (e.g., via beam 1134 associated with the refinement pattern 1124). In some aspects, 1716 may be performed by the pattern transition component 195.

In some aspects, at 1714, the RIS device may receive, from the network entity, an activation indication to activate the one refinement pattern associated with the at least one RIS pattern. The activation indication may be based on a trigger condition being met. The RIS device may communicate with the first UE (e.g., at 1718) based on the one refinement pattern. For example, referring to FIG. 15, the RIS device 1506 may, at 1528, receive from the network entity (e.g., base station 1504) an activation indication to activate the one refinement pattern associated with the at least one RIS pattern. Referring to FIG. 14, the RIS device 1406 may, at 1422 or 1428, receive from the network entity (e.g., base station 1404) an activation indication to activate one refinement pattern associated with the at least one RIS pattern in response to a trigger condition being met (e.g., at 1416). In FIG. 11, the RIS device 1506 may communicate with the first UE (e.g., UE 1112) based on the one refinement pattern (e.g., refinement pattern 1124). In some aspects, 1714 may be performed by the pattern transition component 195.

In some aspects, the trigger condition may include: the occurrence of a mismatch associated with the at least one RIS pattern. The one or more refinement patterns may respectively correspond to one or more ambient temperatures, and the one refinement pattern may correspond to a current ambient temperature in the one or more ambient temperatures. For example, referring to FIG. 11, the trigger condition may include: the occurrence of a mismatch associated with the at least one RIS pattern (e.g., beam 1132′ associated with pattern A 1122 is not aligned with UE 1112). The one or more refinement patterns may respectively correspond to one or more ambient temperatures, and the one refinement pattern (e.g., refinement pattern 1124) may correspond to a current ambient temperature in the one or more ambient temperatures.

In some aspects, at 1702, the RIS device may transmit, to the network entity, temperature information comprising the current ambient temperature. For example, referring to FIG. 15, the RIS device 1506 may, at 1510, transmit to the network entity (e.g., base station 1504) temperature information including the current ambient temperature.

In some aspects, the trigger condition may include one or more of: a gain margin of the one refinement pattern meets a margin condition, or a leakage constraint is met by the associated one refinement pattern. For example, referring to FIG. 12, the trigger condition may include one or more of: a gain margin of the one refinement pattern (e.g., refinement pattern 1224) meets a margin condition, or a leakage constraint is met by the associated one refinement pattern (e.g., the leakage associated with refinement pattern 1224 is below a leakage threshold).

In some aspects, the trigger condition may further include: a switch time from the at least one RIS pattern to the one refinement pattern associated with the one RIS pattern being less than a switch time threshold. For example, referring to FIG. 14, at 1424, the base station 1404 may consider the switch time (e.g., the switch time is less than a threshold time) from the at least one RIS pattern to the one refinement pattern associated with the one RIS pattern when selecting the candidate configuration from stage-2 codebook (e.g., refinement pattern).

In some aspects, at 1712, the RIS device may perform RIS pattern transitions that are time-aligned with configured grant operations with multiple UEs including the first UE respectively using one or more RIS patterns in the first set of RIS patterns according to a communication order of the one or more RIS patterns. The communication order is based on the transition time information corresponding to the one or more RIS patterns and the one or more refinement patterns associated with the at least one RIS pattern. For example, referring to FIG. 13A and FIG. 15, the RIS device 1506 may, at 1526, perform RIS pattern transitions that are time-aligned with configured grant operations with multiple UEs (e.g., UE 1 1312, UE 2 1314, UE 3 1316) including the first UE respectively using one or more RIS patterns (e.g., pattern A 1322, pattern B 1324, pattern C 1326) in the set of RIS patterns according to a communication order of the one or more RIS patterns. The communication order is based on the transition time information corresponding to the one or more RIS patterns and the one or more refinement patterns associated with the at least one RIS pattern (e.g., refinement pattern of pattern B 1324 at 1382 and 1384).

In some aspects, the RIS device includes liquid crystal (LC) based RIS elements. For example, RIC device 806, 906, 1006, 1106, 1206, 1306 may include LC-based RIS elements.

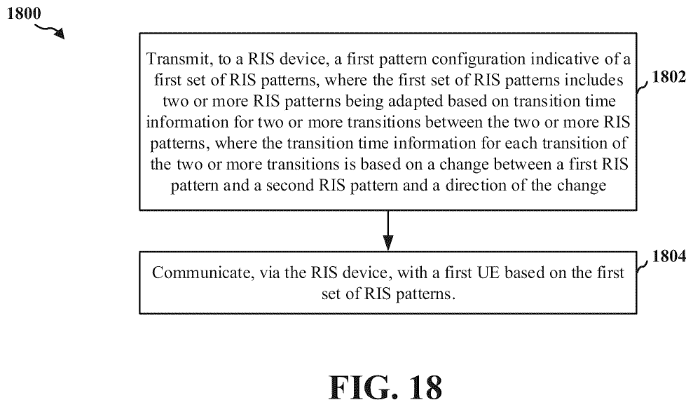

FIG. 18 is a flowchart 1800 illustrating methods of wireless communication at a network entity in accordance with various aspects of the present disclosure. The method may be performed by a network entity in collaboration with an RIS device and a UE (e.g., the first UE). The RIS device may be RIS device 806, 906, 1006, 1106, 1206, 1306, 1406, 1506; or RIS 2340 in the hardware implementation of FIG. 23. The network entity may be a base station, or a component of a base station, in the access network of FIG. 1 or a core network component (e.g., base station 102, 310, 804, 904, 1004, 1104, 1204, 1304, 1404, 1504; or the network entity 2102 in the hardware implementation of FIG. 21). The UE may be the UE 104, 350, 1112, 1212, 1502, UE 1 912, 1312, UE 2 914, 1314, UE 3 916, 1316, or the apparatus 2104 in the hardware implementation of FIG. 21. By utilizing transition time information for the transitions between the RIS patterns to optimize the beam orders in various operations, including beam sweeping and/or burst communication, the methods reduce the time to adjust the RIS configuration across multiple patterns, thereby improving the overall responsiveness of the network to changes in network condition and environment. Additionally, by configuring refinement (or second-stage) codebooks with associated pattern transition times, margins, and ambient temperature information, the methods can be used to adjust the RIS configurations based on environmental changes such as temperature fluctuations, thereby maintaining optimal signal quality and reducing the risk of service degradation or interruption due to environmental factors. In some examples, by enabling dynamic adjustment of RIS configurations in response to updated interference requirements and ambient conditions, the methods maintain optimal signal reflection and directionality, thereby ensuring efficient use of the RIS device under varying network load and interference conditions.

As shown in FIG. 18, at 1802, the network entity may transmit, to the RIS device, a first pattern configuration indicative of a first set of RIS patterns. The first set of RIS patterns may include two or more RIS patterns, which may be adapted based on transition time information for two or more transitions between the two or more RIS patterns, and the transition time information for each transition of the two or more transitions may be based on a change between a first RIS pattern and a second RIS pattern and a direction of the change. FIG. 8, FIG. 9A, FIG. 9B, FIG. 10, FIG. 11, FIG. 12, FIG. 13A, FIG. 13B, FIG. 14, and FIG. 15 illustrate various aspects of the steps in connection with flowchart 1800. For example, referring to FIG. 8 and FIG. 15, the network entity (e.g., base station 1504) may, at 1514, transmit to the RIS device 1506 a first pattern configuration indicative of a first set of RIS patterns (e.g., pattern A 822, pattern B 824, pattern C 826). The first set of RIS patterns (e.g., pattern A 822, pattern B 824, pattern C 826) may be adapted based on transition time information for two or more transitions, and the transition time information for each transition of the two or more transitions may be based on a change of the RIS pattern between a first RIS pattern (pattern A 822) and a second RIS pattern (pattern B 824) and the direction of the change. In some aspects, 1802 may be performed by the pattern transition component 199.

At 1804, the network entity may communicate with a first UE via the RIS device based on the first set of RIS patterns. For example, referring to FIG. 15, the network entity (e.g., base station 1504) may, at 1532, communicate with a first UE (e.g., UE 1502) via the RIS device 1506 based on the first set of RIS patterns. In some aspects, 1804 may be performed by the pattern transition component 199.

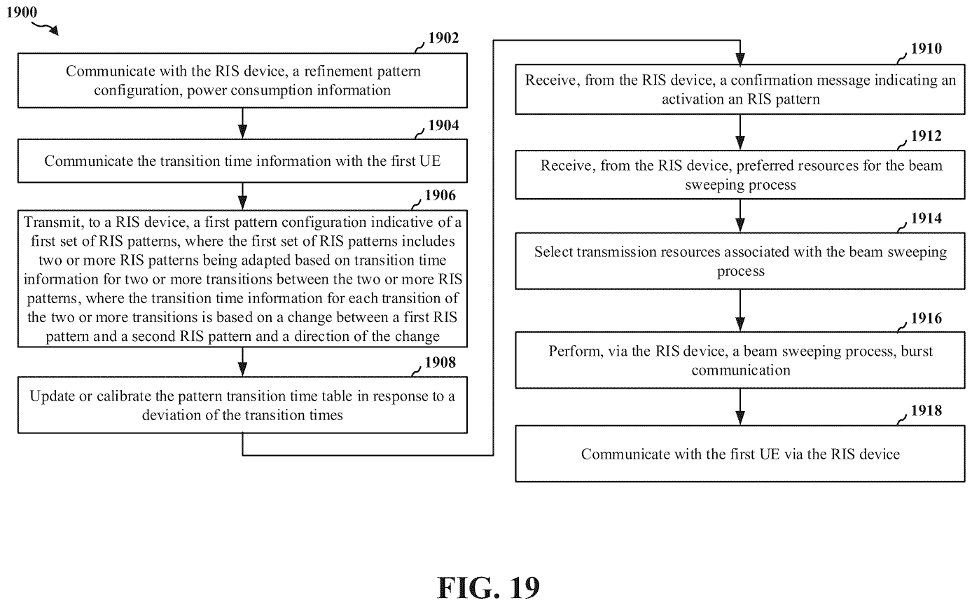

FIG. 19 is a flowchart 1900 illustrating methods of wireless communication at a network entity in accordance with various aspects of the present disclosure. The method may be performed by a network entity in collaboration with an RIS device and a UE (e.g., the first UE). The RIS device may be RIS device 806, 906, 1006, 1106, 1206, 1306, 1406, 1506; or RIS 2340 in the hardware implementation of FIG. 23. The network entity may be a base station, or a component of a base station, in the access network of FIG. 1 or a core network component (e.g., base station 102, 310, 804, 904, 1004, 1104, 1204, 1304, 1404, 1504; or the network entity 2102 in the hardware implementation of FIG. 21). The UE may be the UE 104, 350, 1112, 1212, 1502, UE 1 912, 1312, UE 2 914, 1314, UE 3 916, 1316, or the apparatus 2104 in the hardware implementation of FIG. 21. By utilizing transition time information for the transitions between the RIS patterns to optimize the beam orders in various operations, including beam sweeping and/or burst communication, the methods reduce the time to adjust the RIS configuration across multiple patterns, thereby improving the overall responsiveness of the network to changes in network condition and environment. Additionally, by configuring refinement (or second-stage) codebooks with associated pattern transition times, margins, and ambient temperature information, the methods can be used to adjust the RIS configurations based on environmental changes such as temperature fluctuations, thereby maintaining optimal signal quality and reducing the risk of service degradation or interruption due to environmental factors. In some examples, by enabling dynamic adjustment of RIS configurations in response to updated interference requirements and ambient conditions, the methods maintain optimal signal reflection and directionality, thereby ensuring efficient use of the RIS device under varying network load and interference conditions.

As shown in FIG. 19, at 1906, the network entity may transmit, to the RIS device, a first pattern configuration indicative of a first set of RIS patterns. The first set of RIS patterns may include two or more RIS patterns, which may be adapted based on transition time information for two or more transitions between the two or more RIS patterns. The transition time information for each transition of the two or more transitions may be based on a change of the RIS pattern between a first RIS pattern and a second RIS pattern and a direction of the change. FIG. 8, FIG. 9A, FIG. 9B, FIG. 10, FIG. 11, FIG. 12, FIG. 13A, FIG. 13B, FIG. 14, and FIG. 15 illustrate various aspects of the steps in connection with flowchart 1900. For example, referring to FIG. 8 and FIG. 15, the network entity (e.g., base station 1504) may, at 1514, transmit to the RIS device 1506 a first pattern configuration indicative of a first set of RIS patterns (e.g., pattern A 822, pattern B 824, pattern C 826). The first set of RIS patterns (e.g., pattern A 822, pattern B 824, pattern C 826) may be adapted based on transition time information for two or more transitions, and the transition time information for each transition of the two or more transitions may be based on a change of the RIS pattern between a first RIS pattern (pattern A 822) and a second RIS pattern (pattern B 824) and the direction of the change. In some aspects, 1906 may be performed by the pattern transition component 199.

At 1918, the network entity may communicate with a first UE via the RIS device based on, for example, the first set of RIS patterns. For example, referring to FIG. 15, the network entity (e.g., base station 1504) may, at 1532, communicate with a first UE (e.g., UE 1502) via the RIS device 1506 based on the first set of RIS patterns. In some aspects, 1918 may be performed by the pattern transition component 199.

In some aspects, the network entity may determine the first set of RIS patterns based on the transition time information for the two or more transitions between the two or more RIS patterns. For example, referring to FIG. 15, at 1513, the network entity (e.g., base station 1504) may determine the first set of RIS patterns based on the transition time information (e.g., received at 1512) for the two or more transitions between the two or more RIS pattern.

In some aspects, at 1904, the network entity may communicate the transition time information with the first UE. For example, referring to FIG. 15, the network entity (e.g., base station 1504) may, at 1510, communicate the transition time information with the first UE (e.g., UE 1502). In some aspects, 1904 may be performed by the pattern transition component 199.

In some aspects, the transition time information may include one or more common transition times respectively corresponding to one or more groups of RIS patterns in the first set of RIS patterns. For example, referring to FIG. 15, the transition time information (e.g., at 1510) may include one or more common transition times respectively corresponding to one or more groups of RIS patterns in the first set of RIS patterns.

In some aspects, the transition time information may include a pattern transition time table, and the entries of the pattern transition time table include transition times between two RIS patterns. For example, referring to FIG. 7, the transition time information may include a PAT table 740, and the entries of the PAT table 740 may include transition times between two RIS patterns (e.g., 722 and 724).

In some aspects, at 1908, the network entity may update or calibrate the pattern transition time table in response to a deviation of the transition times. For example, referring to FIG. 15, the network entity (e.g., base station 1504) may, at 1517, update or calibrate the pattern transition time table (e.g., PAT table 740) in response to a deviation of the transition times. In some aspects, 1908 may be performed by the pattern transition component 199.

In some aspects, the network entity may, at 1910, receive, from the RIS device, a confirmation message indicating an activation an RIS pattern in response to an time for a transition to the RIS pattern being less than a threshold time. For example, referring to FIG. 15, the network entity (e.g., base station 1504) may, at 1518, transmit to the RIS device 1506 a second pattern configuration for a second set of RIS patterns and, at 1520, receive from the RIS device 1506 a confirmation message indicating an activation of the second set of RIS patterns in response to a time for transitioning to the second set of RIS patterns being less than a threshold time. In some aspects, 1910 may be performed by the pattern transition component 199.

In some aspects, at 1902, the network entity may receive, from the RIS device, power consumption information corresponding to multiple operational modes for the two or more transitions. The multiple operational modes include a regular mode and a fast mode. A regular transition time under the regular mode is longer than a fast transition time under the fast mode for the two or more transitions, and the first pattern configuration is based on the power consumption information. For example, referring to FIG. 15, the network entity (e.g., base station 1504) may, at 1510, receive from the RIS device 1506 power consumption information corresponding to multiple operational modes for the two or more transitions. The multiple operational modes include a regular mode and a fast mode. A regular transition time under the regular mode is longer than a fast transition time under the fast mode for the two or more transitions, and the first pattern configuration is based on the power consumption information.

In some aspects, at 1916, the network entity may perform, via the RIS device, a beam sweeping process using one or more RIS patterns in the first set of RIS patterns according to a sweeping order of the one or more RIS patterns, and the sweeping order may be based on the transition time information corresponding to the one or more RIS patterns. For example, referring to FIG. 8 and FIG. 15, the network entity (e.g., base station 1504) may, at 1526, via the RIS device 1506, perform a beam sweeping process using one or more RIS patterns (e.g., pattern A 822, pattern B 824, pattern C 826) in the first set of RIS patterns according to a sweeping order of the one or more RIS patterns. The sweeping order may be based on the transition time information corresponding to the one or more RIS patterns (e.g., pattern A 822, pattern B 824, pattern C 826). In some aspects, 1916 may be performed by the pattern transition component 199.

In some aspects, the total transition time based on the sweeping order of the one or more RIS patterns is shorter than or equal to an alternative total transition time based on an alternative order of the one or more RIS patterns different from the sweeping order. For example, referring to FIG. 8, by considering the transition time information between pattern A 822, pattern B 824, pattern C 826 and arranging the order of these patterns accordingly, the total transition time may be reduced (e.g., shorter than an order that does not consider the transition time information).

In some aspects, at 1914, the network entity may select transmission resources associated with the beam sweeping process using the one or more RIS patterns in the first set of RIS patterns based on the transition time information corresponding to the one or more RIS patterns. For example, referring to FIG. 15, the network entity (e.g., base station 1504) may, at 1524, select transmission resources associated with the beam sweeping process using the one or more RIS patterns in the first set of RIS patterns based on the transition time information corresponding to the one or more RIS patterns. In some aspects, 1914 may be performed by the pattern transition component 199.

In some aspects, at 1912, the network entity may receive, from the RIS device, preferred resources for the beam sweeping process. To select the transmission resources associated with the beam sweeping process (e.g., at 1914), the network entity may select the transmission resources associated with the beam sweeping process based on the preferred resources. For example, referring to FIG. 15, the network entity (e.g., base station 1504) may, at 1522, receive from the RIS device 1506 preferred resources for the beam sweeping process. To select the transmission resources associated with the beam sweeping process (e.g., at 1524), the network entity (e.g., base station 1504) may select the transmission resources associated with the beam sweeping process based on the preferred resources (e.g., at 1522). In some aspects, 1912 may be performed by the pattern transition component 199.

In some aspects, at 1916, the network entity may perform, via the RIS device, burst communication with multiple UEs including the first UE respectively using one or more RIS patterns in the first set of RIS patterns according to a communication order of the one or more RIS patterns. The communication order is based on the transition time information corresponding to the one or more RIS patterns. For example, referring to FIG. 9A and FIG. 15, the network entity (e.g., base station 1504) may, at 1526, via the RIS device 1506, perform burst communication with multiple UEs (e.g., UE 1 912, UE 2 914, UE 3 916) including the first UE respectively using one or more RIS patterns (e.g., pattern A 922, pattern B 924, pattern C 926) in the set of RIS patterns according to a communication order of the one or more RIS patterns. The communication order may be based on the transition time information corresponding to the one or more RIS patterns (e.g., pattern A 922, pattern B 924, pattern C 926). For example, by considering the transition time information between pattern A 922, pattern B 924, pattern C 926 and arranging the order of these patterns accordingly, the total communication time for burst communication may be reduced (e.g., shorter than an order that does not consider the transition time information).

In some aspects, at least one RIS pattern in the first set of RIS patterns may be associated with one or more refinement patterns, and the association of the at least one RIS pattern with the one or more refinement patterns may be based on the transition time information for the transitions among the at least one RIS pattern and the one or more refinement patterns. For example, referring to FIG. 10, at least one RIS pattern (e.g., stage-1 codeword 1030) in the first set of RIS patterns may be associated with one or more refinement patterns (e.g., stage-2 codewords 1042, 1044, 1046), and the association of the at least one RIS pattern (e.g., stage-1 codeword 1030) with the one or more refinement patterns (e.g., stage-2 codewords 1042, 1044, 1046) may be based on the transition time information for the transitions among the at least one RIS pattern (e.g., stage-1 codeword 1030) and the one or more refinement patterns (e.g., stage-2 codewords 1042, 1044, 1046).

In some aspects, the one or more refinement patterns may be associated with the at least one RIS pattern via a QCL relation (e.g., a spatial QCL relation), and the one or more refinement patterns respectively may correspond to multiple gain margins within a margin range. For example, referring to FIG. 10, the one or more refinement patterns (e.g., stage-2 codewords 1042, 1044, 1046) may be associated with the at least one RIS pattern (e.g., stage-1 codeword 1030) via a QCL relation (e.g., a spatial QCL relation), and the one or more refinement patterns (e.g., stage-2 codewords 1042, 1044, 1046) may respectively correspond to multiple gain margins within a margin range (e.g., the stage-2 codewords 1042, 1044, 1046 may respectively correspond to multiple gain margins within a margin range of the gain margin of stage-1 codeword 1030).

In some aspects, at 1902, the network entity may communicate, with the RIS device, refinement pattern configuration indicative of one or more refinement patterns associated with the at least one RIS pattern in the first set of RIS patterns. For example, referring to FIG. 15, the network entity (e.g., base station 1504) may, at 1510, communicate with the RIS device 1506 a refinement pattern configuration indicative of the one or more refinement patterns associated with the at least one RIS pattern in the first set of RIS patterns.

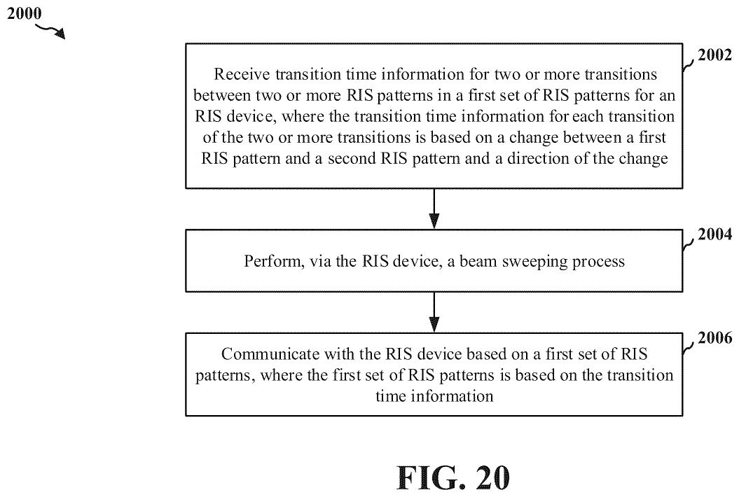

FIG. 20 is a flowchart 2000 illustrating methods of wireless communication at a UE in accordance with various aspects of the present disclosure. The method may be performed by a UE in collaboration with a network entity and an RIS device. The RIS device may be RIS device 806, 906, 1006, 1106, 1206, 1306, 1406, 1506; or RIS 2340 in the hardware implementation of FIG. 23. The network entity may be a base station, or a component of a base station, in the access network of FIG. 1 or a core network component (e.g., base station 102, 310, 804, 904, 1004, 1104, 1204, 1304, 1404, 1504; or the network entity 2102 in the hardware implementation of FIG. 21). The UE may be the UE 104, 350, 1112, 1212, 1502, UE 1 912, 1312, UE 2 914, 1314, UE 3 916, 1316, or the apparatus 2104 in the hardware implementation of FIG. 21. By utilizing transition time information for the transitions between the RIS patterns to optimize the beam orders in various operations, including beam sweeping and/or burst communication, the methods reduce the time to adjust the RIS configuration across multiple patterns, thereby improving the overall responsiveness of the network to changes in network condition and environment. Additionally, by configuring refinement (or second-stage) codebooks with associated pattern transition times, margins, and ambient temperature information, the methods can be used to adjust the RIS configurations based on environmental changes such as temperature fluctuations, thereby maintaining optimal signal quality and reducing the risk of service degradation or interruption due to environmental factors. In some examples, by enabling dynamic adjustment of RIS configurations in response to updated interference requirements and ambient conditions, the methods maintain optimal signal reflection and directionality, thereby ensuring efficient use of the RIS device under varying network load and interference conditions.

As shown in FIG. 20, at 2002, the UE may receive transition time information for two or more transitions between two or more RIS patterns in a first set of RIS patterns for an RIS device. The transition time information for each transition of the two or more transitions of the RIS device is be based on the change between a first RIS pattern and a second RIS pattern and the direction of the change. FIG. 8, FIG. 9A, FIG. 9B, FIG. 10, FIG. 11, FIG. 12, FIG. 13A, FIG. 13B, FIG. 14, and FIG. 15 illustrate aspects of the steps in connection with flowchart 2000. For example, referring to FIG. 15, the UE 1502 may, at 1512, receive transition time information associated with the RIS device 1506. The transition time information may include two or more transition times for two or more transitions between two or more RIS patterns of the RIS device, and each transition of the two or more transitions may be based on the change between a first RIS pattern (e.g., pattern A 822) and a second RIS pattern (e.g., pattern B 824) and the direction of the change. In some aspects, 2002 may be performed by the pattern transition component 198.

At 2006, the UE may communicate with the RIS device based on a first set of RIS patterns. The first set of RIS patterns may be based on the transition time information. For example, referring to FIG. 15, the UE 1502 may, at 1532, communicate with the RIS device 1506 based on a first set of RIS patterns. The first set of RIS patterns may be based on the transition time information (e.g., at 1512). In some aspects, 2006 may be performed by the pattern transition component 198.

In some aspects, the transition time information may include a pattern transition time table, and the entries of the pattern transition time table include transition times between two RIS patterns. For example, referring to FIG. 7, the transition time information may include a PAT table 740, and the entries of the PAT table 740 may include transition times between two RIS patterns (e.g., 722 and 724).

In some aspects, the transition time table may include a first entry and a second entry corresponding to the transition between the first RIS pattern and the second RIS pattern, and the first entry may correspond to a first transition time from the first RIS pattern to the second RIS pattern, and the second entry corresponds to a second transition time from the second RIS pattern to the first RIS pattern. For example, referring to FIG. 7, the PAT table 740 may include a first entry 702 and a second entry 704 corresponding to the transition between the first RIS pattern (e.g., 722) and the second RIS pattern (e.g., 724), and the first entry 702 may correspond to a first transition time from the first RIS pattern (e.g., 722) to the second RIS pattern (e.g., 724), and the second entry 704 corresponds to a second transition time from the second RIS pattern (e.g., 724) to the first RIS pattern (e.g., 722).

In some aspects, the transition time information may include one or more common transition times respectively corresponding to one or more groups of RIS patterns in the first set of RIS patterns. For example, referring to FIG. 15, the transition time information (e.g., at 1512) may include one or more common transition times respectively corresponding to one or more groups of RIS patterns in the first set of RIS patterns.

In some aspects, at 2004, the UE may perform, via the RIS device, a beam sweeping process using one or more RIS patterns in the set of RIS patterns according to a sweeping order of the one or more RIS patterns. The sweeping order may be based on the transition time information corresponding to the one or more RIS patterns. For example, referring to FIG. 8 and FIG. 15, the UE 1502 may, at 1526, perform, via the RIS device 1506, a beam sweeping process using one or more RIS patterns (e.g., pattern A 822, pattern B 824, pattern C 826) in the set of RIS patterns according to a sweeping order of the one or more RIS patterns. The sweeping order may be based on the transition time information corresponding to the one or more RIS patterns (e.g., pattern A 822, pattern B 824, pattern C 826). In some aspects, 2004 may be performed by the pattern transition component 198.

FIG. 21 is a diagram 2100 illustrating an example of a hardware implementation for an apparatus 2104. The apparatus 2104 may be a UE, a component of a UE, or may implement UE functionality. In some aspects, the apparatus 2104 may include at least one cellular baseband processor (or processing circuitry) 2124 (also referred to as a modem) coupled to one or more transceivers 2122 (e.g., cellular RF transceiver). The cellular baseband processor(s) (or processing circuitry) 2124 may include at least one on-chip memory (or memory circuitry) 2124′. In some aspects, the apparatus 2104 may further include one or more subscriber identity modules (SIM) cards 2120 and at least one application processor (or processing circuitry) 2106 coupled to a secure digital (SD) card 2108 and a screen 2110. The application processor(s) (or processing circuitry) 2106 may include on-chip memory (or memory circuitry) 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize the antennas 2180 for communication. The cellular baseband processor(s) (or processing circuitry) 2124 communicates through the transceiver(s) 2122 via one or more antennas 2180 with the UE 104 and/or with an RU associated with a network entity 2102. The cellular baseband processor(s) (or processing circuitry) 2124 and the application processor(s) (or processing circuitry) 2106 may each include a computer-readable medium/memory (or memory circuitry) 2124′, 2106′, respectively. The additional memory modules 2126 may also be considered a computer-readable medium/memory (or memory circuitry). Each computer-readable medium/memory (or memory circuitry) 2124′, 2106′, 2126 may be non-transitory. The cellular baseband processor(s) (or processing circuitry) 2124 and the application processor(s) (or processing circuitry) 2106 are each responsible for general processing, including the execution of software stored on the computer-readable medium/memory (or memory circuitry). The software, when executed by the cellular baseband processor(s) (or processing circuitry) 2124/application processor(s) (or processing circuitry) 2106, causes the cellular baseband processor(s) (or processing circuitry) 2124/application processor(s) (or processing circuitry) 2106 to perform the various functions described supra. The cellular baseband processor(s) (or processing circuitry) 2124 and the application processor(s) (or processing circuitry) 2106 are configured to perform the various functions described supra based at least in part of the information stored in the memory (or memory circuitry). That is, the cellular baseband processor(s) (or processing circuitry) 2124 and the application processor(s) (or processing circuitry) 2106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 2124/application processor(s) (or processing circuitry) 2106 when executing software. The cellular baseband processor(s) (or processing circuitry) 2124/application processor(s) (or processing circuitry) 2106 may be a component of the UE 350 and may include the at least one memory 360 and/or at least one of the TX processor 368, the RX processor 356, and the controller/processor 359. In one configuration, the apparatus 2104 may be at least one processor chip (modem and/or application) and include just the cellular baseband processor(s) (or processing circuitry) 2124 and/or the application processor(s) (or processing circuitry) 2106, and in another configuration, the apparatus 2104 may be the entire UE (e.g., see UE 350 of FIG. 3) and include the additional modules of the apparatus 2104.

As discussed supra, the component 198 may be configured to receive transition time information for two or more transitions between two or more reconfigurable intelligent surface (RIS) patterns in a first set of RIS patterns for an RIS device, where the transition time information for each transition of the two or more transitions is based on a change between a first RIS pattern and a second RIS pattern and a direction of the change; and communicate with the RIS device based on the first set of RIS patterns. The first set of RIS patterns is based on the transition time information. The component 198 may be further configured to perform any of the aspects described in connection with the flowchart in FIG. 20, and/or performed by the UE 1502 in FIG. 15. The component 198 may be within the cellular baseband processor(s) (or processing circuitry) 2124, the application processor(s) (or processing circuitry) 2106, or both the cellular baseband processor(s) (or processing circuitry) 2124 and the application processor(s) (or processing circuitry) 2106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2104 may include a variety of components configured for various functions. In one configuration, the apparatus 2104, and in particular the cellular baseband processor(s) (or processing circuitry) 2124 and/or the application processor(s) (or processing circuitry) 2106, includes means for receiving transition time information for two or more transitions between two or more reconfigurable intelligent surface (RIS) patterns in a first set of RIS patterns for an RIS device, where the transition time information for each transition of the two or more transitions is based on a change between a first RIS pattern and a second RIS pattern and a direction of the change; and means for communicating with the RIS device based on the first set of RIS patterns. The first set of RIS patterns is based on the transition time information. The apparatus 2104 may further include means for performing any of the aspects described in connection with the flowchart in FIG. 20, and/or aspects performed by the UE 1502 in FIG. 15. The means may be the component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

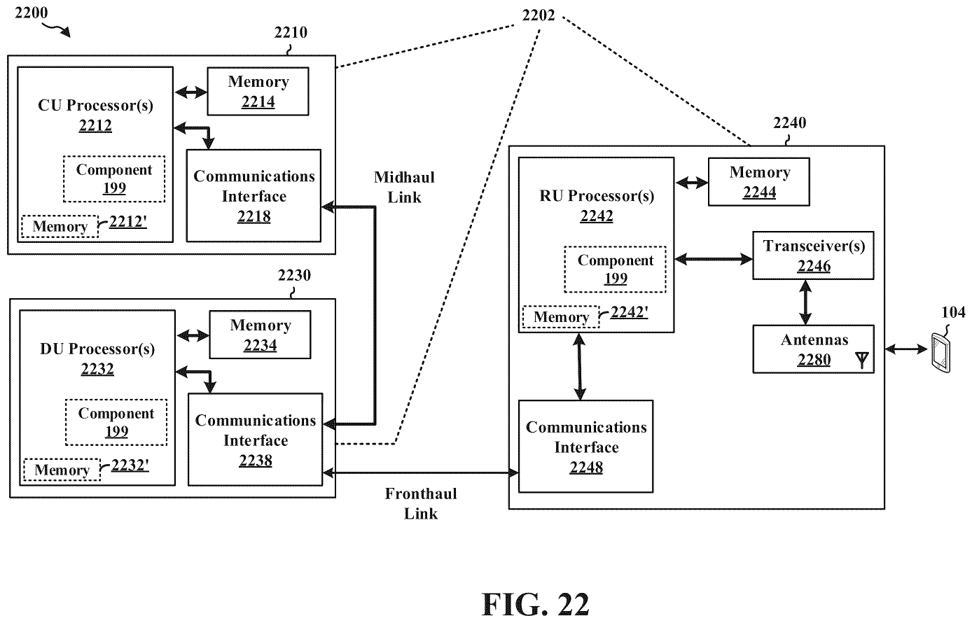

FIG. 22 is a diagram 2200 illustrating an example of a hardware implementation for a network entity 2202. The network entity 2202 may be a BS, a component of a BS, or may implement BS functionality. The network entity 2202 may include at least one of a CU 2210, a DU 2230, or an RU 2240. For example, depending on the layer functionality handled by the component 199, the network entity 2202 may include the CU 2210; both the CU 2210 and the DU 2230; each of the CU 2210, the DU 2230, and the RU 2240; the DU 2230; both the DU 2230 and the RU 2240; or the RU 2240. The CU 2210 may include at least one CU processor (or processing circuitry) 2212. The CU processor(s) (or processing circuitry) 2212 may include on-chip memory (or memory circuitry) 2212′. In some aspects, the CU 2210 may further include additional memory modules 2214 and a communications interface 2218. The CU 2210 communicates with the DU 2230 through a midhaul link, such as an F1 interface. The DU 2230 may include at least one DU processor (or processing circuitry) 2232. The DU processor(s) (or processing circuitry) 2232 may include on-chip memory (or memory circuitry) 2232′. In some aspects, the DU 2230 may further include additional memory modules 2234 and a communications interface 2238. The DU 2230 communicates with the RU 2240 through a fronthaul link. The RU 2240 may include at least one RU processor (or processing circuitry) 2242. The RU processor(s) (or processing circuitry) 2242 may include on-chip memory (or memory circuitry) 2242′. In some aspects, the RU 2240 may further include additional memory modules 2244, one or more transceivers 2246, antennas 2280, and a communications interface 2248. The RU 2240 communicates with the UE 104. The on-chip memory (or memory circuitry) 2212′, 2232′, 2242′ and the additional memory modules 2214, 2234, 2244 may each be considered a computer-readable medium/memory (or memory circuitry). Each computer-readable medium/memory (or memory circuitry) may be non-transitory. Each of the processors (or processing circuitry) 2212, 2232, 2242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to an RIS device, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and communicate, via the RIS device, with a first UE based on the first set of RIS patterns. The component 199 may be further configured to perform any of the aspects described in connection with the flowcharts in FIG. 18 and FIG. 19, and/or performed by the base station 1504 in FIG. 15. The component 199 may be within one or more processors (or processing circuitry) of one or more of the CU 2210, DU 2230, and the RU 2240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2202 may include a variety of components configured for various functions. In one configuration, the network entity 2202 includes means for transmitting, to an RIS device, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and means for communicating, via the RIS device, with a first UE based on the first set of RIS patterns. The network entity 2202 may further include means for performing any of the aspects described in connection with the flowcharts in FIG. 18 and FIG. 19, and/or aspects performed by the base station 1504 in FIG. 15. The means may be the component 199 of the network entity 2202 configured to perform the functions recited by the means. As described supra, the network entity 2202 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 23 is a diagram 2300 illustrating an example of a hardware implementation for an RIS 2340. The RIS 2340 includes an RIS surface 2390 that includes a passive antenna array 2380. The RIS surface 2390 includes a surface with a large number of densely placed reconfigurable elements that can reflect or refract an electromagnetic wave in target directions. FIG. 23 illustrates an example of the RIS surface 2390 reflecting communication between a UE 104 and a base station 102. The RIS 2340 includes a controller 2341 that controls an incident angle and an angle of reflection, e.g., by controlling reflection coefficients of the antenna elements of the RIS surface 2390. The controller 2341 may exchange communication, including control signaling or other signaling with a network node such as a base station 102 or a component of a base station 102 and/or a UE 104. The controller 2341 may exchange the communication via at least one transceiver 2346. The controller 2341 may include a processor 2342. The processor 2342 may include on-chip memory 2342′. In some aspects, the controller 2341 may further include additional memory modules 2344. The on-chip memory 2342′ and the additional memory modules 2344 may each be considered a computer-readable medium/memory. Each computer-readable medium/memory may be non-transitory. The processor 2342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 195 may be configured to receive, from a network entity, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and communicate with a first UE based on the first set of RIS patterns. The component 195 may be within the processor 2342. The component 195 may be one or more hardware components specifically configured to carry out the stated processes/algorithm, implemented by one or more processors configured to perform the stated processes/algorithm, stored within a computer-readable medium for implementation by one or more processors, or some combination thereof. The RIS 2340 may include a variety of components configured for various functions. In one configuration, the RIS 2340 may include means for receiving, from a network entity, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and means for communicating with a first UE based on the first set of RIS patterns. The means may be the component 195 of the RIS 2340 configured to perform the functions recited by the means.

This disclosure provides a method for wireless communication at an RIS device. The method may include receiving, from a network entity, a first pattern configuration indicative of a first set of RIS patterns, where the first set of RIS patterns includes two or more RIS patterns being adapted based on transition time information for two or more transitions between the two or more RIS patterns, where the transition time information for each transition of the two or more transitions is based on a change between a first RIS pattern and a second RIS pattern and a direction of the change; and communicating with a first UE based on the first set of RIS patterns. By utilizing transition time information for the transitions between the RIS patterns to optimize the beam orders in various operations, including beam sweeping and/or burst communication, the methods reduce the time to adjust the RIS configuration across multiple patterns, thereby improving the overall responsiveness of the network to changes in network condition and environment. Additionally, by configuring refinement (or second-stage) codebooks with associated pattern transition times, margins, and ambient temperature information, the methods can be used to adjust the RIS configurations based on environmental changes such as temperature fluctuations, thereby maintaining optimal signal quality and reducing the risk of service degradation or interruption due to environmental factors. In some examples, by enabling dynamic adjustment of RIS configurations in response to updated interference requirements and ambient conditions, the methods maintain optimal signal reflection and directionality, thereby ensuring efficient use of the RIS device under varying network load and interference conditions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a reconfigurable intelligent surface (RIS) device. The method includes receiving, from a network entity, a first pattern configuration indicative of a first set of RIS patterns, wherein the first set of RIS patterns includes two or more RIS patterns being adapted based on transition time information for two or more transitions between the two or more RIS patterns, wherein the transition time information for each transition of the two or more transitions is based on a change between a first RIS pattern and a second RIS pattern and a direction of the change; and communicating with a first user equipment (UE) based on the first set of RIS patterns.

Aspect 2 is the method of aspect 1, wherein the transition time information includes a pattern transition time table, wherein entries of the pattern transition time table include transition times between the two or more RIS patterns, and wherein the first pattern configuration includes the first set of RIS patterns according to an order, wherein the order is based on the transition time information.

Aspect 3 is the method of aspect 2, wherein the transition time table includes a first entry and a second entry corresponding to the transition between the first RIS pattern and the second RIS pattern, wherein the first entry corresponds to a first transition time from the first RIS pattern to the second RIS pattern, and the second entry corresponds to a second transition time from the second RIS pattern to the first RIS pattern.

Aspect 4 is the method of aspect 2, wherein the transition times in the pattern transition time table are specified in a unit of time, a slot, or a symbol, and wherein the transition times are further based on a sub-carrier spacing (SCS) when the transition times are specified in the unit of the slot or the symbol.

Aspect 5 is the method of any of aspects 1 to 4, wherein the first set of RIS patterns include two or more pattern groups of RIS patterns, wherein the transition time information includes an intra-group transition time and inter-group transition information, wherein the intra-group transition time corresponds to intra-group transitions between any two RIS patterns of the RIS patterns within one pattern group of the two or more pattern groups of RIS patterns, and the inter-group transition information corresponds to inter-group transitions between any two RIS patterns on different pattern groups of the two or more pattern groups.

Aspect 6 is the method of aspect 5, wherein the inter-group transition information includes a common inter-group transition time for the inter-group transitions between any two RIS patterns on the different pattern groups of the two or more pattern groups.

Aspect 7 is the method of aspect 5, wherein the inter-group transition information includes one or more inter-group transition times respectively corresponding to the inter-group transitions between the RIS patterns on the different pattern groups of the two or more pattern groups.

Aspect 8 is the method of any of aspects 1 to 4, wherein the transition time information includes a common transition time and a corresponding transition offset for each of the two or more transitions, wherein the transition time between two RIS patterns is represented by a combination of the common transition time and the corresponding transition offset.

Aspect 9 is the method of any of aspects 1 to 4, wherein the transition time information includes a first traverse time and a second traverse time, wherein the first traverse time corresponds to a first traverse of one or more RIS patterns in the first set of RIS patterns based on a first order, and the second traverse time corresponds to a second traverse of the one or more RIS patterns in the first set of RIS patterns based on a reverse of the first order.

Aspect 10 is the method of aspect 2, wherein the method further includes reporting an update or a calibration on the pattern transition time table in response to a deviation of the transition times.

Aspect 11 is the method of any of aspects 1 to 4, wherein the method further includes transmitting, to the network entity, a confirmation message indicating an activation of an RIS pattern in response to a time for a transition to the RIS pattern being less than a threshold time.

Aspect 12 is the method of any of aspects 1 to 4, wherein the method further includes transmitting, to the network entity, power consumption information corresponding to multiple operational modes for the two or more transitions, wherein the multiple operational modes include a regular mode and a fast mode, wherein a regular transition time under the regular mode is longer than a fast transition time under the fast mode for the two or more transitions, and wherein the first pattern configuration is based on the power consumption information.

Aspect 13 is the method of any of aspects 1 to 4, wherein the method further includes performing RIS pattern transitions that are time-aligned with a beam sweeping process using one or more RIS patterns in the first set of RIS patterns according to a sweeping order of the one or more RIS patterns, wherein the sweeping order is based on the transition time information corresponding to the one or more RIS patterns.

Aspect 14 is the method of aspect 13, wherein a total transition time based on the sweeping order of the one or more RIS patterns is shorter than or equal to an alternative transition time based on an alternative order of the one or more RIS patterns different from the sweeping order.

Aspect 15 is the method of aspect 13, wherein transmission resources associated with the beam sweeping process using the one or more RIS patterns in the first set of RIS patterns are based on the transition time information corresponding to the one or more RIS patterns.

Aspect 16 is the method of aspect 15, wherein the method further includes indicating, to the network entity, preferred resources for the beam sweeping process, and wherein the transmission resources associated with the beam sweeping process are based on the preferred resources.

Aspect 17 is the method of any of aspects 1 to 4, wherein the method further includes performing RIS pattern transitions that are time-aligned with burst communication with multiple UEs including the first UE respectively using one or more RIS patterns in the first set of RIS patterns according to a communication order of the one or more RIS patterns, wherein the communication order is based on the transition time information corresponding to the one or more RIS patterns.

Aspect 18 is the method of aspect 17, wherein a total communication time of the burst communication based on the communication order of the one or more RIS patterns is shorter than or equal to an alternative total communication time based on an alternative order of the one or more RIS patterns different from the communication order.

Aspect 19 is the method of aspect 1, wherein at least one RIS pattern in the first set of RIS patterns is associated with one or more refinement patterns, wherein an association of the at least one RIS pattern with the one or more refinement patterns is based on the transition time information for the transitions among the at least one RIS pattern and the one or more refinement patterns.

Aspect 20 is the method of aspect 19, wherein the one or more refinement patterns are associated with the at least one RIS pattern via a spatial relation, and the one or more refinement patterns respectively correspond to multiple gain margins within a margin range.

Aspect 21 is the method of aspect 20, wherein the method further includes communicating, with the network entity, a refinement pattern configuration indicative of the one or more refinement patterns associated with the at least one RIS pattern in the first set of RIS patterns.

Aspect 22 is the method of aspect 21, wherein the method further includes activating one refinement pattern associated with the at least one RIS pattern based on an ambient temperature; and communicating with the first UE based on the one refinement pattern.

Aspect 23 is the method of aspect 21, wherein the method further includes receiving, from the network entity, an activation indication to switch from the at least one RIS pattern to one refinement pattern associated with the at least one RIS pattern, wherein the activation indication is based on a trigger condition being met; and communicating with the first UE based on the one refinement pattern.

Aspect 24 is the method of aspect 23, wherein the trigger condition includes an occurrence of a mismatch associated with the at least one RIS pattern, and wherein the one or more refinement patterns respectively correspond to one or more ambient temperatures, and wherein the one refinement pattern corresponds to a current ambient temperature in the one or more ambient temperatures.

Aspect 25 is the method of aspect 24, wherein the method further includes transmitting, to the network entity, temperature information comprising the current ambient temperature.

Aspect 26 is the method of aspect 23, wherein the trigger condition includes one or more of a gain margin of the one refinement pattern meets a margin condition; or a leakage constraint is met by the associated one refinement pattern.

Aspect 27 is the method of aspect 23, wherein the trigger condition further includes a switch time from the at least one RIS pattern to the one refinement pattern associated with the one RIS pattern being less than a switch time threshold.

Aspect 28 is the method of aspect 19, wherein the method further includes performing RIS pattern transitions that are time-aligned with configured grant operations with multiple UEs including the first UE respectively using one or more RIS patterns in the first set of RIS patterns according to a communication order of the one or more RIS patterns, wherein the communication order is based on the transition time information corresponding to the one or more RIS patterns and the one or more refinement patterns associated with the at least one RIS pattern.

Aspect 29 is the method of any of aspects 1 to 28, wherein the RIS device includes liquid crystal (LC) based RIS elements.

Aspect 30 is an apparatus for wireless communication at an RIS device, comprising: at least one memory; and at least one processor coupled to the at least one memory, the at least one processor is configured to perform the method of any of aspects 1 to 29.

Aspect 31 is the apparatus for wireless communication at an RIS device, comprising means for performing each step in the method of any of aspects 1-29.

Aspect 32 is an apparatus of any of aspects 30-31, further comprising a transceiver configured to receive or to transmit in association with the method of any of aspects 1-29.

Aspect 33 is a computer-readable medium (e.g., a non-transitory computer-readable medium) storing computer executable code at an RIS device, the code when executed by at least one processor causes the at least one processor to perform the method of any of aspects 1-29.

Aspect 34 is a method of wireless communication at a network entity. The method includes transmitting, to a reconfigurable intelligent surface (RIS) device, a first pattern configuration indicative of a first set of RIS patterns, wherein the first set of RIS patterns includes two or more RIS patterns being adapted based on transition time information for two or more transitions between the two or more RIS patterns, wherein the transition time information for each transition of the two or more transitions is based on a change between a first RIS pattern and a second RIS pattern and a direction of the change; and communicating, via the RIS device, with a first user equipment (UE) based on the first set of RIS patterns.

Aspect 35 is the method of aspect 34, wherein the method further includes determining the first set of RIS patterns based on the transition time information for the two or more transitions between the two or more RIS patterns.

Aspect 36 is the method of any of aspects 34 to 35, wherein the method further includes communicating the transition time information with the first UE.

Aspect 37 is the method of any of aspects 34 to 36, wherein the transition time information includes one or more common transition times respectively corresponding to one or more groups of RIS patterns in the first set of RIS patterns.

Aspect 38 is the method of any of aspects 34 to 37, wherein the transition time information includes a pattern transition time table, wherein entries of the pattern transition time table include transition times between two RIS patterns.

Aspect 39 is the method of aspect 38, wherein the method further includes updating or calibrating the pattern transition time table in response to a deviation of the transition times.

Aspect 40 is the method of aspect 34, wherein the method further includes receiving, from the RIS device, a confirmation message indicating an activation of an RIS pattern in response to a time for a transition to the RIS pattern being less than a threshold time.

Aspect 41 is the method of aspect 34, wherein the method further includes receiving, from the RIS device, power consumption information corresponding to multiple operational modes for the two or more transitions, wherein the multiple operational modes include a regular mode and a fast mode, wherein a regular transition time under the regular mode is longer than a fast transition time under the fast mode for the two or more transitions, and wherein the first pattern configuration is based on the power consumption information.

Aspect 42 is the method of aspect 34, wherein the method further includes performing, via the RIS device, a beam sweeping process using one or more RIS patterns in the first set of RIS patterns according to a sweeping order of the one or more RIS patterns, wherein the sweeping order is based on the transition time information corresponding to the one or more RIS patterns.

Aspect 43 is the method of aspect 42, wherein a total transition time based on the sweeping order of the one or more RIS patterns is shorter than or equal to an alternative total transition time based on an alternative order of the one or more RIS patterns different from the sweeping order.

Aspect 44 is the method of aspect 42, wherein the method further includes selecting transmission resources associated with the beam sweeping process using the one or more RIS patterns in the first set of RIS patterns based on the transition time information corresponding to the one or more RIS patterns.

Aspect 45 is the method of aspect 44, wherein the method further includes receiving, from the RIS device, preferred resources for the beam sweeping process, and wherein selecting the transmission resources associated with the beam sweeping process comprises selecting the transmission resources associated with the beam sweeping process based on the preferred resources.

Aspect 46 is the method of aspect 34, wherein the method further includes performing, via the RIS device, burst communication with multiple UEs including the first UE respectively using one or more RIS patterns in the first set of RIS patterns according to a communication order of the one or more RIS patterns, wherein the communication order is based on the transition time information corresponding to the one or more RIS patterns.

Aspect 47 is the method of aspect 34, wherein at least one RIS pattern in the first set of RIS patterns is associated with one or more refinement patterns, wherein an association of the at least one RIS pattern with the one or more refinement patterns is based on the transition time information for the transitions among the at least one RIS pattern and the one or more refinement patterns.

Aspect 48 is the method of aspect 47, wherein the one or more refinement patterns are associated with the at least one RIS pattern via a spatial relation, and the one or more refinement patterns respectively correspond to multiple gain margins within a margin range.

Aspect 49 is the method of aspect 48, wherein the method further includes indicating, to the RIS device, a refinement pattern information configuration indicative of the one or more refinement patterns associated with the at least one RIS pattern in the first set of RIS patterns.

Aspect 50 is an apparatus for wireless communication at a network entity, comprising: at least one memory; and at least one processor coupled to the at least one memory and, where the at least one processor is configured to perform the method of any of aspects 34-49.

Aspect 51 is the apparatus for wireless communication at a network entity, comprising means for performing each step in the method of any of aspects 34-49.

Aspect 52 is an apparatus of any of aspects 50-51, further comprising a transceiver configured to receive or to transmit in association with the method of any of aspects 34-49.

Aspect 53 is a computer-readable medium (e.g., a non-transitory computer-readable medium) storing computer executable code at a network entity, the code when executed by at least one processor causes the at least one processor to perform the method of any of aspects 34-49.

Aspect 54 is a method of wireless communication at a user equipment (UE). The method includes receiving transition time information for two or more transitions between two or more reconfigurable intelligent surface (RIS) patterns in a first set of RIS patterns for an RIS device, wherein the transition time information for each transition of the two or more transitions is based on a change between a first RIS pattern and a second RIS pattern and a direction of the change; and communicating with the RIS device based on the first set of RIS patterns, wherein the first set of RIS patterns is based on the transition time information.

Aspect 55 is the method of aspect 54, wherein the transition time information includes a pattern transition time table, wherein entries of the pattern transition time table include transition times between the two or more RIS patterns.

Aspect 56 is the method of aspect 55, wherein the transition time table includes a first entry and a second entry corresponding to the transition between the first RIS pattern and the second RIS pattern, wherein the first entry corresponds to a first transition time from the first RIS pattern to the second RIS pattern, and the second entry corresponds to a second transition time from the second RIS pattern to the first RIS pattern.

Aspect 57 is the method of any of aspects 54 to 56, wherein the transition time information includes one or more common transition times respectively corresponding to one or more groups of RIS patterns in the set of RIS patterns.

Aspect 58 is the method of any of aspects 54 to 57, wherein the method further includes performing, via the RIS device, a beam sweeping process using one or more RIS patterns in the first set of RIS patterns according to a sweeping order of the one or more RIS patterns, wherein the sweeping order is based on the transition time information corresponding to the two or more RIS patterns.

Aspect 59 is an apparatus for wireless communication at a UE, comprising: at least one memory; and at least one processor coupled to the at least one memory, the at least one processor is configured to perform the method of any of aspects 54 to 58.

Aspect 60 is the apparatus for wireless communication at a UE, comprising means for performing each step in the method of any of aspects 54 to 58.

Aspect 61 is an apparatus of any of aspects 59-60, further comprising a transceiver configured to receive or to transmit in association with the method of any of aspects 54 to 58.

Aspect 62 is a computer-readable medium (e.g., a non-transitory computer-readable medium) storing computer executable code at a UE, the code when executed by at least one processor causes the at least one processor to perform the method of any of aspects 54 to 58.

What is claimed is:

1. An apparatus for wireless communication at a reconfigurable intelligent surface (RIS) device, comprising:
at least one memory; and
at least one processor coupled to the at least one memory and, based at least in part on information stored in the at least one memory, the at least one processor is configured to cause the apparatus to:
receive, from a network entity, a first pattern configuration indicative of a first set of RIS patterns, wherein the first set of RIS patterns includes two or more RIS patterns being adapted based on transition time information for two or more transitions between the two or more RIS patterns, wherein the transition time information for each transition of the two or more transitions is based on a change between a first RIS pattern and a second RIS pattern and a direction of the change; and
communicate with a first user equipment (UE) based on the first set of RIS patterns.

2. The apparatus of claim 1, wherein the transition time information includes a pattern transition time table, wherein entries of the pattern transition time table include transition times between the two or more RIS patterns, and wherein the first pattern configuration includes the first set of RIS patterns according to an order, wherein the order is based on the transition time information.

3. The apparatus of claim 2, wherein the transition time table includes a first entry and a second entry corresponding to the transition between the first RIS pattern and the second RIS pattern, wherein the first entry corresponds to a first transition time from the first RIS pattern to the second RIS pattern, and the second entry corresponds to a second transition time from the second RIS pattern to the first RIS pattern.

4. The apparatus of claim 2, wherein the transition times in the pattern transition time table are specified in a unit of time, a slot, or a symbol, and wherein the transition times are further based on a sub-carrier spacing (SCS) when the transition times are specified in the unit of the slot or the symbol.

5. The apparatus of claim 1, wherein the first set of RIS patterns include two or more pattern groups of RIS patterns, wherein the transition time information includes an intra-group transition time and inter-group transition information, wherein the intra-group transition time corresponds to intra-group transitions between any two RIS patterns of the RIS patterns within one pattern group of the two or more pattern groups of RIS patterns, and the inter-group transition information corresponds to inter-group transitions between any two RIS patterns on different pattern groups of the two or more pattern groups.

6. The apparatus of claim 5, wherein the inter-group transition information includes a common inter-group transition time for the inter-group transitions between the any two RIS patterns on the different pattern groups of the two or more pattern groups.

7. The apparatus of claim 5, wherein the inter-group transition information includes one or more inter-group transition times respectively corresponding to the inter-group transitions between the RIS patterns on the different pattern groups of the two or more pattern groups.

8. The apparatus of claim 1, wherein the transition time information includes a common transition time and a corresponding transition offset for each of the two or more transitions, wherein the transition time between two RIS patterns is represented by a combination of the common transition time and the corresponding transition offset.

9. The apparatus of claim 1, wherein the transition time information includes a first traverse time and a second traverse time, wherein the first traverse time corresponds to a first traverse of one or more RIS patterns in the first set of RIS patterns based on a first order, and the second traverse time corresponds to a second traverse of the one or more RIS patterns in the first set of RIS patterns based on a reverse of the first order.

10. The apparatus of claim 2, wherein the at least one processor is further configured to cause the apparatus to:
report an update or a calibration on the pattern transition time table in response to a deviation of the transition times.

11. The apparatus of claim 1, wherein the at least one processor is further configured to cause the apparatus to:
transmit, to the network entity, a confirmation message indicating an activation of an RIS pattern in response to a time for a transition to the RIS pattern being less than a threshold time.

12. The apparatus of claim 1, wherein the at least one processor is further configured to cause the apparatus to:
transmit, to the network entity, power consumption information corresponding to multiple operational modes for the two or more transitions, wherein the multiple operational modes include a regular mode and a fast mode, wherein a regular transition time under the regular mode is longer than a fast transition time under the fast mode for the two or more transitions, and wherein the first pattern configuration is based on the power consumption information.

13. The apparatus of claim 1, wherein the at least one processor is further configured to:
perform RIS pattern transitions that are time-aligned with a beam sweeping process using one or more RIS patterns in the first set of RIS patterns according to a sweeping order of the one or more RIS patterns, wherein the sweeping order is based on the transition time information corresponding to the one or more RIS patterns.

14. The apparatus of claim 13, wherein a total transition time based on the sweeping order of the one or more RIS patterns is shorter than or equal to an alternative transition time based on an alternative order of the one or more RIS patterns different from the sweeping order.

15. The apparatus of claim 13, wherein transmission resources associated with the beam sweeping process using the one or more RIS patterns in the first set of RIS patterns are based on the transition time information corresponding to the one or more RIS patterns.

16. The apparatus of claim 15, wherein the at least one processor is further configured to cause the apparatus to:
indicate, to the network entity, preferred resources for the beam sweeping process, and wherein the transmission resources associated with the beam sweeping process are based on the preferred resources.

17. The apparatus of claim 1, wherein the at least one processor is further configured to cause the apparatus to:
perform RIS pattern transitions that are time-aligned with burst communication with multiple UEs including the first UE respectively using one or more RIS patterns in the first set of RIS patterns according to a communication order of the one or more RIS patterns, wherein the communication order is based on the transition time information corresponding to the one or more RIS patterns.

18. The apparatus of claim 17, wherein a total communication time of the burst communication based on the communication order of the one or more RIS patterns is shorter than or equal to an alternative total communication time based on an alternative order of the one or more RIS patterns different from the communication order.

19. The apparatus of claim 1, wherein at least one RIS pattern in the first set of RIS patterns is associated with one or more refinement patterns, wherein an association of the at least one RIS pattern with the one or more refinement patterns is based on the transition time information for the transitions among the at least one RIS pattern and the one or more refinement patterns.

20. The apparatus of claim 19, wherein the one or more refinement patterns are associated with the at least one RIS pattern via a spatial relation, and the one or more refinement patterns respectively correspond to multiple gain margins within a margin range.

21. The apparatus of claim 20, wherein the at least one processor is further configured to cause the apparatus to:
communicate, with the network entity, a refinement pattern configuration indicative of the one or more refinement patterns associated with the at least one RIS pattern in the first set of RIS patterns.

22. The apparatus of claim 21, wherein the at least one processor is further configured to cause the apparatus to:
activate one refinement pattern associated with the at least one RIS pattern based on an ambient temperature; and
communicate with the first UE based on the one refinement pattern.

23. The apparatus of claim 21, wherein the at least one processor is further configured to cause the apparatus to:
receive, from the network entity, an activation indication to activate the one refinement pattern associated with the at least one RIS pattern, wherein the activation indication is based on a trigger condition being met; and
communicate with the first UE based on the one refinement pattern.

24. The apparatus of claim 23, wherein the trigger condition includes:
an occurrence of a mismatch associated with the at least one RIS pattern, and wherein the one or more refinement patterns respectively correspond to one or more ambient temperatures, and wherein the one refinement pattern corresponds a current ambient temperature in the one or more ambient temperatures.

25. The apparatus of claim 24, wherein the at least one processor is further configured to cause the apparatus to:
transmit, to the network entity, temperature information comprising the current ambient temperature.

26. The apparatus of claim 23, wherein the trigger condition includes one or more of:
a gain margin of the one refinement pattern meets a margin condition, or
a leakage constraint is met by the associated one refinement pattern.

27. The apparatus of claim 23, wherein the trigger condition further includes:
a switch time from the at least one RIS pattern to the one refinement pattern associated with the one RIS pattern being less than a switch time threshold.

28. The apparatus of claim 19, wherein the at least one processor is further configured to:
perform RIS pattern transitions that are time-aligned with configured grant operations with multiple UEs including the first UE respectively using one or more RIS patterns in the first set of RIS patterns according to a communication order of the one or more RIS patterns, wherein the communication order is based on the transition time information corresponding to the one or more RIS patterns and the one or more refinement patterns associated with the at least one RIS pattern.

29. The apparatus of claim 1, wherein the RIS device includes liquid crystal (LC) based RIS elements.

30. An apparatus for wireless communication at a network entity, comprising:
at least one memory; and
at least one processor coupled to the at least one memory and, based at least in part on information stored in the at least one memory, the at least one processor is configured to cause the apparatus to:
transmit, to a reconfigurable intelligent surface (RIS) device, a first pattern configuration indicative of a first set of RIS patterns, wherein the first set of RIS patterns includes two or more RIS patterns being adapted based on transition time information for two or more transitions between the two or more RIS patterns, wherein the transition time information for each transition of the two or more transitions is based on a change between a first RIS pattern and a second RIS pattern and a direction of the change; and
communicate, via the RIS device, with a first user equipment (UE) based on the first set of RIS patterns.

31. The apparatus of claim 30, wherein the at least one processor is further configured to cause the apparatus to:
determine the first set of RIS patterns based on the transition time information for the two or more transitions between the two or more RIS patterns.

32. The apparatus of claim 30, wherein the at least one processor is further configured to cause the apparatus to:
communicate the transition time information with the first UE.

33. The apparatus of claim 30, wherein the transition time information includes one or more common transition times respectively corresponding to one or more groups of RIS patterns in the first set of RIS patterns.

34. The apparatus of claim 30, wherein the transition time information includes a pattern transition time table, wherein entries of the pattern transition time table include transition times between two RIS patterns.

35. The apparatus of claim 34, wherein the at least one processor is further configured to cause the apparatus to:
update or calibrate the pattern transition time table in response to a deviation of the transition times.

36. The apparatus of claim 30, wherein the at least one processor is further configured to cause the apparatus to:
receive, from the RIS device, a confirmation message indicating an activation of an RIS pattern in response to a time for a transition to the RIS pattern being less than a threshold time.

37. The apparatus of claim 30, wherein the at least one processor is further configured to cause the apparatus to:
receive, from the RIS device, power consumption information corresponding to multiple operational modes for the two or more transitions, wherein the multiple operational modes include a regular mode and a fast mode, wherein a regular transition time under the regular mode is longer than a fast transition time under the fast mode for the two or more transitions, and wherein the first pattern configuration is based on the power consumption information.

38. The apparatus of claim 30, wherein the at least one processor is further configured to cause the apparatus to:
perform, via the RIS device, a beam sweeping process using one or more RIS patterns in the first set of RIS patterns according to a sweeping order of the one or more RIS patterns, wherein the sweeping order is based on the transition time information corresponding to the one or more RIS patterns.

39. The apparatus of claim 38, wherein a total transition time based on the sweeping order of the one or more RIS patterns is shorter than or equal to an alternative total transition time based on an alternative order of the one or more RIS patterns different from the sweeping order.

40. The apparatus of claim 38, wherein the at least one processor is further configured to cause the apparatus to:
select transmission resources associated with the beam sweeping process using the one or more RIS patterns in the first set of RIS patterns based on the transition time information corresponding to the one or more RIS patterns.

41. The apparatus of claim 40, wherein the at least one processor is further configured to cause the apparatus to:
receive, from the RIS device, preferred resources for the beam sweeping process, and wherein to select the transmission resources associated with the beam sweeping process, the at least one processor is configured to:
select the transmission resources associated with the beam sweeping process based on the preferred resources.

42. The apparatus of claim 30, wherein the at least one processor is further configured to cause the apparatus to:
perform, via the RIS device, burst communication with multiple UEs including the first UE respectively using one or more RIS patterns in the first set of RIS patterns according to a communication order of the one or more RIS patterns, wherein the communication order is based on the transition time information corresponding to the one or more RIS patterns.

43. The apparatus of claim 30, wherein at least one RIS pattern in the first set of RIS patterns is associated with one or more refinement patterns, wherein an association of the at least one RIS pattern with the one or more refinement patterns is based on the transition time information for the transitions among the at least one RIS pattern and the one or more refinement patterns.

44. The apparatus of claim 43, wherein the one or more refinement patterns are associated with the at least one RIS pattern via a spatial relation, and the one or more refinement patterns respectively correspond to multiple gain margins within a margin range.

45. The apparatus of claim 44, wherein the at least one processor is further configured to cause the apparatus to:
indicate, to the RIS device, a refinement pattern information configuration indicative of the one or more refinement patterns associated with the at least one RIS pattern in the first set of RIS patterns.

46. An apparatus for wireless communication at a user equipment (UE), comprising:
at least one memory; and
at least one processor coupled to the at least one memory and, based at least in part on information stored in the at least one memory, the at least one processor is configured to cause the apparatus to:
receive transition time information for two or more transitions between two or more reconfigurable intelligent surface (RIS) patterns in a first set of RIS patterns for an RIS device, wherein the transition time information for each transition of the two or more transitions is based on a change between a first RIS pattern and a second RIS pattern and a direction of the change; and
communicate with the RIS device based on the first set of RIS patterns, wherein the first set of RIS patterns is based on the transition time information.

47. The apparatus of claim 46, wherein the transition time information includes a pattern transition time table, wherein entries of the pattern transition time table include transition times between the two or more RIS patterns.

48. The apparatus of claim 47, wherein the transition time table includes a first entry and a second entry corresponding to the transition between the first RIS pattern and the second RIS pattern, wherein the first entry corresponds to a first transition time from the first RIS pattern to the second RIS pattern, and the second entry corresponds to a second transition time from the second RIS pattern to the first RIS pattern.

49. The apparatus of claim 46, wherein the transition time information includes one or more common transition times respectively corresponding to one or more groups of RIS patterns in the set of RIS patterns.

50. The apparatus of claim 46, wherein the at least one processor is further configured to cause the apparatus to:
perform, via the RIS device, a beam sweeping process using one or more RIS patterns in the first set of RIS patterns according to a sweeping order of the one or more RIS patterns, wherein the sweeping order is based on the transition time information corresponding to the two or more RIS patterns.
